(19) United States
(12) Patent Application Publication
(10) Pub. No.: US 2002/0007251 A1
(43) Pub. Date: Jan. 17, 2002

(54) Apparatus and method for computing electromagnetic field intensity, and method for displaying computation result

(76) Inventors: Yoshiro Tanaka, Kawasaki (JP); Katsumi Homma, Kawasaki (JP); Takeshi Kishimoto, Kawasaki (JP); Mokoto Mukai, Kawasaki (JP); Shinichi Ohtsu, Kawasaki (JP)

Correspondence Address: STAAS & HALSEY LLP, 700 11TH STREET, NW, SUITE 500, WASHINGTON, DC, 20001, US

(21) Appl. No.: 09/805,158

(22) Filed: Mar. 14, 2001

(30) Foreign Application Priority Data
Jun. 14, 2000 (JP) 2000-179085

(51) Int. Cl. G06F 19/00

(52) U.S. Cl. 702/65

(57) ABSTRACT

An analytic frequency determination unit determines the range of an analytic frequency used in a moment method as a range nearest to the lowest value of the analytic frequency in the frequencies whose real parts of frequency responses are 0. A transient analysis unit obtains an impulse response as a transient analysis corresponding an analytic frequency in the determined range.

### BACKGROUND OF THE INVENTION

1. Field of the Invention

The present invention relates to a system of computing the intensity of the electromagnetic field generated by an electric circuit device, and more specifically to an electromagnetic field intensity computation apparatus and a computing method capable of stably computing an impulse response by performing a computing process by classifying an analysis model into a closed circuit and an open circuit, and capable of reducing the amount of computation in computing the electromagnetic field intensity.

2. Description of the Related Art

Since an electromagnetic wave emitted from an electric circuit device interferes with other electric waves of, for example, TV, radio, etc., it has been strictly restricted in many countries in the world. The restriction standards include the VCCI Standards in Japan, the FCC Standards in the U.S., and the VDE Standards in Germany.

To satisfy these restrictions on electric waves, it is necessary to take various countermeasures such as the shielding technology, the filter technology, etc., and quantitatively simulate how these technologies can reduce the emission of electromagnetic waves. Under the situation, an electromagnetic field intensity computation apparatus is required to compute with high precision the intensity of an electromagnetic field generated by an electric circuit device.

The intensity of an electromagnetic field generated by an object of an arbitrary shape can be easily computed only if an electric current through each portion of the object is obtained. The current value can also be logically obtained by solving a Maxwell electromagnetic field equation in a given boundary condition. However, a logical solution for an object of an arbitrary shape under a complicated boundary condition has not been successfully obtained.

Therefore, any solution using a current electromagnetic field intensity computation apparatus is an approximate method. There are two typical approximate methods, that is, a circuit analysis such as a distributed constant line approximation method, etc. and a moment method.

The distributed constant line approximation method obtains a current by applying an equation of a distributed constant line (transmission line) to an object which can be approximated as a one-dimensional structure. The computation is relatively simple. That is, the computing time and storage capacity increase substantially in proportion to the number of analysis elements, thereby analyzing such phenomena as the reflection, the oscillation of a line, etc.

The computation by the distributed constant line approximation method has the problem that a high-speed and high-precision analysis can be performed on an object to be approximated as a one-dimensional structure, but cannot be performed on an object which cannot be approximated.

On the other hand, the moment method is one of the solutions to an integral equation using an electromagnetic field, and can process a three-dimensional object of an arbitrary shape. Practically, an object is divided into small elements, and is processed in current computation.

In the moment method, a mutual impedance, admittance, etc. among meshed elements (patch and wire) are computed based on a given frequency, and an analysis is performed by solving simultaneous equations using the computation results. However, the computation of the mutual impedance, etc. takes a long time, and a time domain is converted into a frequency domain with a large number of converted frequencies each of which requires the computation of a mutual impedance, etc., thereby taking a considerably long processing time.

In addition, a processing time required to solve the simultaneous equations is largely prolonged with an increasing number of simultaneous equations. The computing time of simultaneous equations is determined by the size of a coefficient matrix of the simultaneous equations. That is, when the coefficient matrix is formed by n rows and n columns, the amount of computation is determined by n, and the computation order is the order of n³. For example, when the size of the coefficient matrix doubles, the computing time octuples.

Thus, although it is very important to correctly compute the intensity of the electromagnetic field generated by an electric circuit device, a specific device is required to compute the electromagnetic field intensity when the electric circuit device contains a nonlinear element, that is, a semiconductor, an IC, etc. One method is described in the following document.

[Document] “Transient Analysis of Electromagnetic Systems with Multiple Lumped Nonlinear Loads”, IEEE Trans. on Antennas and Propagation, Vol. AP-33, No.5, (May, 1985)

In the system described in the above mentioned document, an impulse response is computed regardless of the feature of a model to be analyzed, and a transient analysis and an electromagnetic wave analysis are performed using the computation results.

However, in this method, an analysis is performed without distinction between an object such as an antenna whose circuit is not connected, that is, an open circuit model, and an object such as a transmission line whose circuit is connected, that is, a closed circuit model. A waveform obtained as an analysis result, for example, a result that a voltage waveform is dispersed, is obtained for some models.

FIGS. 1 and 2 show an example of a voltage waveform as the above mentioned analysis result. These figures show the result obtained by computing the voltage on the output side of a transmission line, that is, on the load side after applying a step voltage of 5 V high (VV1) on the wave source side as shown in FIGS. 1 and 2. FIG. 1 shows an example of an open circuit on the load side. FIG. 2 shows an example of connecting a capacity load. In both example, the voltage on the load side (VR1, VR2) is dispersed as an analysis result.

In the method described in the above mentioned document, as the number of analytic frequencies increases in a frequency response as a result of an impulse response, the computing time required to solve simultaneous equations in the moment method is prolonged. In addition, the amount of convolutional computation performed when a time response is computed as an inverse Fourier transform of a frequency response greatly increases with a growing scale of a model, thereby causing the problem that a large volume of computation is required.

Regardless of containing a nonlinear element, it is necessary that the above mentioned electromagnetic field intensity computation apparatus to display the computation result of the electromagnetic field intensity, an intermediate result such as the voltage waveform, etc. as shown in FIGS. 1 and 2 on an appropriate scale to the users of the electromagnetic field intensity computation apparatus so that they can correctly understand the analysis result. For example, in FIG. 2, it is not certain how the amplitude of the oscillation changes beyond 500 ns. For example, to confirm whether or not the amplitude increases to a certain extent, and then becomes constant, the voltage scale on the vertical axis should be changed with the time scale on the horizontal axis.

The above mentioned change is made by the user instructing a display device to change the display while monitoring the display. FIG. 3 is a flowchart of an example of the conventional display changing process. By referring an example of extending the full scale of the time on the horizontal axis shown in FIG. 2 from 500 ns to 400 μs, the process is described below by referring to FIGS. 4A, 4, and 5.

In step S101 shown in FIG. 3, from the contents of the value box shown in FIG. 4A, that is, the memory storing values to be selected, 400 is selected or input as a full-scale value of a new horizontal axis. In step S102 shown in FIG. 3, a new time unit μs is specified from the unit box shown in FIG. 4B. In step S103, an input confirmation button, that is, an “Enter” or “OK” button is clicked. In step S104, the change is reflected by the waveform display. With the full scale of 400 μs set on the horizontal axis shown in FIG. 2, the voltage waveform is displayed in a considerably larger time range than in FIG. 2. When the user requests to change a full scale value on the vertical axis shown in FIG. 2, the process is similarly repeated from step S101, and the voltage range on the vertical axis can be changed, for example, for ±50 V.

FIG. 5 shows the value and the contents of a unit display area when the full scale on the horizontal axis is changed from 500 ns to 400 μs. In the initial state, the full scale on the horizontal axis is 500 ns as shown in FIG. 2, and the value of 400 is selected from the value box in step S101, thereby changing the value of the value range from 500 to 400. In step S102, μs is specified as a unit in the unit box, the unit is changed from ns to μs, the input confirmation button OK is clicked in step S103, and the full scale change result on the horizontal axis is reflected on the display.

However, in this display change process system, for example, when the full scale on the horizontal axis is stepwise changed, it is necessary to repeatedly change a value and a unit and click the input conformation button. Furthermore, for example, when the full scale on the horizontal axis is set too large, the value of the full scale is to be changed again into a smaller value for the optimum display result, thereby causing the problem that the user cannot easily obtain the optimum display result.

As described above, since an analyzing process is performed without distinction between an open circuit model and a closed circuit model in the conventional electromagnetic field intensity analysis system, a waveform obtained by the analysis, for example, a voltage waveform is dispersed for some models.

In addition, in the conventional system, an enormously long computing time is required to solve simultaneous equations in the moment method with an increasing number of analytic frequencies in a frequency response, and the amount of convolutional computation quickly increases corresponding to the scale of a model when a time response is obtained as an inverse Fourier transform.

Furthermore, in the conventional analysis result display process change system, users cannot easily obtain the optimum display result.

### SUMMARY OF THE INVENTION

The first object of the present invention is to classify the analysis model of an electric circuit device to be processed in the computation of the electromagnetic field intensity into a closed circuit model and an open circuit model, and compute an impulse response corresponding to each model, thereby preventing the dispersion of a waveform as an analysis result, and computing a stable impulse response.

The second object is to decrease the number of analytic frequencies in the frequency response for determination of the amount of computation of a solution of simultaneous equations in the computation in the moment method, and limit the number of impulses in the impulse column forming a time response, thereby quickly performing the time response computation.

The third object is to provide an analysis result display system capable of automatically and stepwise changing the value and the unit of the full scale on the horizontal axis by a user clicking a control button several times when a waveform is displayed as a result of or during the process of computing the electromagnetic field intensity, thereby automatically, continuously, and stepwise changing a display result and allowing the user to easily perform the entire process.

According to an aspect of the present invention to attain the above mentioned first object, an electromagnetic field intensity computation apparatus for computing the intensity of the electromagnetic field from an electric circuit device containing a nonlinear element includes: a pseudo-DC analyzing unit for performing a pseudo-DC analysis on an analysis model of the electric circuit device using the lowest frequency to which the moment method can be applied; a model classification unit for classifying the analysis model into a closed circuit model and an open circuit model depending on the size of a pseudo-DC value obtained as a result of the pseudo-DC analysis; and a transient analysis unit for performing the transient analysis corresponding to the classification result on the analysis model. The model classification unit determines, for example, an open circuit model when a pseudo-DC value is nearly zero (0), and a closed circuit model when it is somewhat large. Thus, by discriminating an analysis model whether it is a closed circuit model or an open circuit model, different transient analysis processes can be performed for the closed circuit model and the open circuit model, thereby suppressing the fluctuation or the dispersion of a solution as an analysis result.

According to an aspect of the present invention to attain the above mentioned second object, an electromagnetic field intensity computation apparatus for computing the intensity of the electromagnetic field from an electric circuit device containing a nonlinear element includes an analytic frequency determination unit or limiting the range of an analytic frequency used in an analysis in the moment method in a frequency domain. The transient analysis unit performs the transient analysis on an analysis model in the limited range of the analytic frequency. The analytic frequency determination unit limits, for example, the range of the analytic frequency to the range up to the frequency closest to the lowest value of the analytic frequency in the frequencies having the real part of 0 in the frequency response as a result of the impulse response for the analysis model of the electric circuit device. Thus, the transient analysis computing process can be quickly performed.

According to an aspect of the present invention to attain the above mentioned third object, an electromagnetic field intensity computation apparatus for computing the intensity of the electromagnetic field from an electric circuit device containing a nonlinear element stepwise and automatically changes and displays the display scale and the display unit of an analysis result at an instruction of the user input to a display instruction input unit (one control button) Thus, the user can display a process result in a desired display format only by operating one control button without setting a display unit, etc.

### BRIEF DESCRIPTION OF THE DRAWINGS

FIG. 1 shows the dispersion (1) of the voltage waveform according to the electromagnetic wave analysis of the conventional technology;

FIG. 2 shows the dispersion (2) of the voltage waveform according to the electromagnetic wave analysis of the conventional technology;

FIG. 3 is a flowchart of the electromagnetic field intensity analysis result display changing process according to the conventional technology;

FIGS. 4A and 4B show the value box and the unit box;

FIG. 5 shows an example of the contents of the display area of the values and units in the conventional analysis result display system;

FIGS. 6A and 6B are block diagrams of the configuration showing the principle of the present invention;

FIG. 7 shows the concept of the electromagnetic field intensity computation system according to the present invention;

FIG. 8 shows a model for combining the moment method with a circuit analysis;

FIG. 9 shows a method of obtaining a time response by an inverse Fourier transform from the frequency response obtained in the moment method;

FIG. 10 is a flowchart of the entire process of the electromagnetic field intensity computation apparatus;

FIG. 11 is a flowchart of the entire process of a transient analysis;

FIG. 12 is a detailed flowchart of the impulse response computing process;

FIG. 13 is a detailed flowchart of the method of determining the number of analytic frequencies in the moment method;

FIG. 14 shows a real part and an imaginary part (1) of a frequency response;

FIG. 15 shows a real part and an imaginary part (2) of a frequency response;

FIG. 16 shows a time response for frequency responses I₀₀ and I₁₀;

FIG. 17 shows an enlarged view of the first portion shown in FIG. 16;

FIG. 18 shows the time response of the frequency responses I₀₁ and I₁₀;

FIG. 19 shows an enlarged view of the first portion shown in FIG. 18;

FIG. 20 is a flowchart of the pulse duration number setting process;

FIG. 21 is a detailed flowchart of the high band oscillation preventing process performed on a closed circuit model;

FIG. 22 shows the ideal impulse obtained by dividing the largest impulse in the time response into two impulses;

FIG. 23 shows a model of an antenna as an open circuit model;

FIG. 24 shows a transmission line as an example of a closed circuit model;

FIG. 25 shows an enlarged view on the wave source side shown in FIG. 24;

FIG. 26 shows an enlarged view on the load side shown in FIG. 24;

FIG. 27 shows a voltage waveform applied to the wave source side;

FIG. 28 shows the voltage waveform on the load side added to the voltage waveform on the wave source side shown in FIG. 27;

FIG. 29 shows a voltage waveform obtained when a port on the load side is terminated with matched resistor;

FIG. 30 is an enlarged view of the first portion shown in FIG. 29;

FIG. 31 shows a voltage waveform obtained when a capacitor is connected to the port on the load side;

FIG. 32 shows a voltage waveform obtained when a diode is connected to the port on the load side;

FIG. 33 shows an example of computation performed on an antenna model;

FIG. 34 shows an antenna model for the example of the computation shown in FIG. 33;

FIG. 35 is a flowchart of the electromagnetic field intensity analysis result display changing process according to the present invention;

FIG. 36 shows an up-down control button;

FIG. 37 shows a value box, a display area of an analysis result, and a unit box;

FIG. 38 shows an example of an operation when a down control button is clicked;

FIG. 39 shows an example of a display of a waveform viewer;

FIG. 40 shows an example of a display of an input impedance;

FIG. 41 shows an example (1) of a display change result in the waveform viewer;

FIG. 42 shows an example (2) of a display change result in the waveform viewer;

FIG. 43 shows an example (3) of a display change result in the waveform viewer;

FIG. 44 shows an example (4) of a display change result in the waveform viewer;

FIG. 45 shows an example (5) of a display change result in the waveform viewer;

FIG. 46 shows an example (6) of a display change result in the waveform viewer;

FIG. 47 shows an example (7) of a display change result in the waveform viewer;

FIG. 48 shows the configuration of the computer system for realizing the present invention; and

FIG. 49 shows the configuration of the hardware of the information processing device for realizing the present invention.

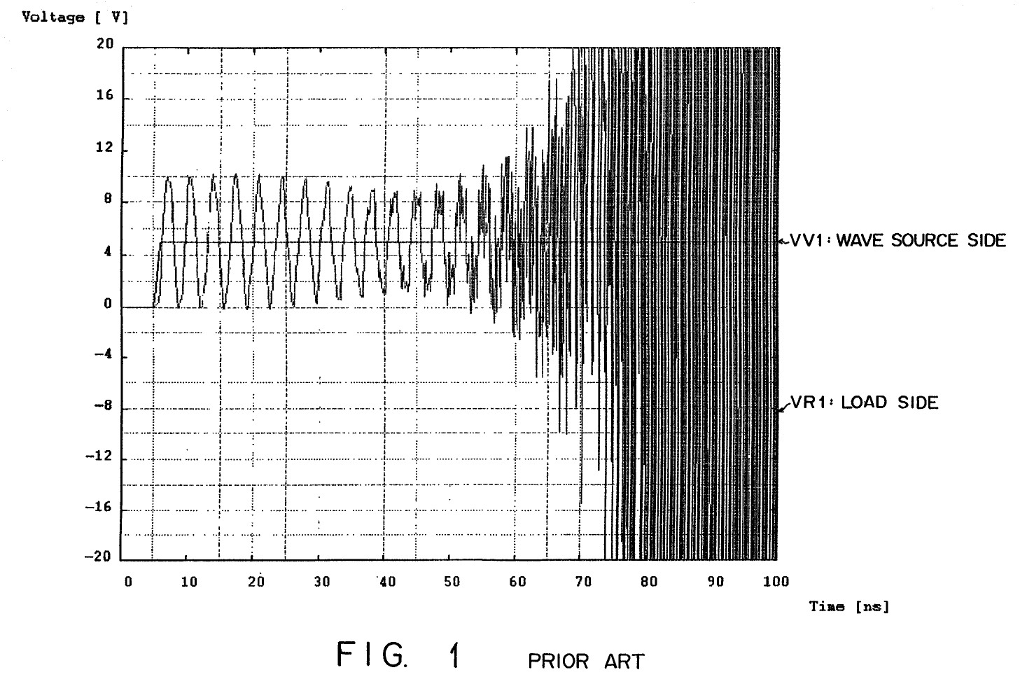

### DESCRIPTION OF THE PREFERRED EMBODIMENTS

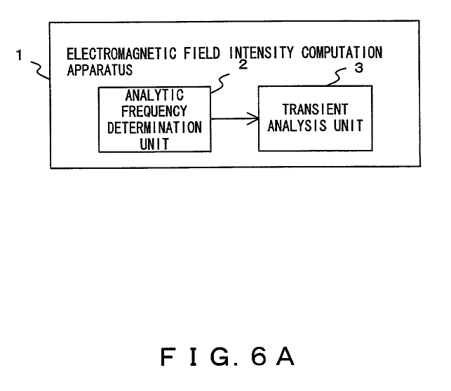

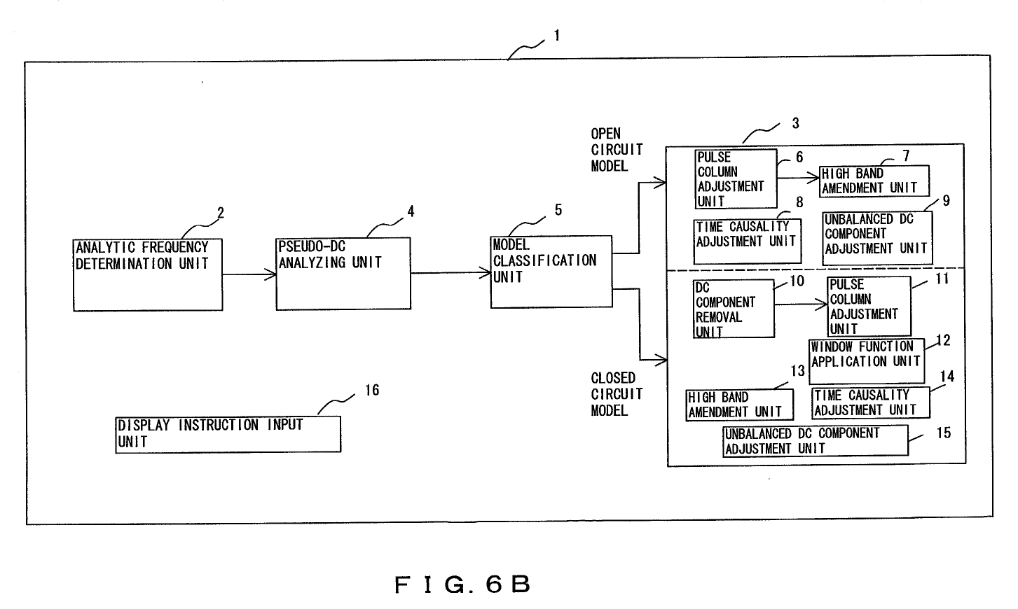

FIGS. 6A and 6B are block diagrams of the configuration showing the principle of the present invention, that is, an electromagnetic field intensity computation apparatus 1 for computing the intensity of the electromagnetic field from an electric circuit device containing a nonlinear element, for example, a semiconductor. The apparatus 1 comprises an analytic frequency determination unit 2 and a transient analysis unit

The analytic frequency determination unit 2 limits the range of the analytic frequency used in the analysis in the moment method in a frequency domain corresponding to the analysis condition of the intensity of the electromagnetic field from an electric circuit device, for example, the analysis condition provided by a user. For example, it determines the range of the analytic frequency for those up to the frequency having the value nearest to the smallest value of the analytic frequency in the frequencies having a real part of 0 in the frequency response obtained as a result of the impulse response for an analysis model of the electric circuit device. The transient analysis unit 3 performs a transient analysis on an analysis model corresponding to the range of the analytic frequency determined by the analytic frequency determination unit 2.

Furthermore in detail, as shown in FIG. 6B, the apparatus further comprises a pseudo-DC analyzing unit 4 and a model classification unit 5, for example, between the analytic frequency determination unit 2 and the transient analysis unit 3.

The pseudo-DC analyzing unit 4 performs a pseudo-DC analysis on an analysis model of the electric circuit device as an analysis at an ultra low frequency in the frequencies to which the moment method can be applied. The model classification unit 5 classifies the analysis model into a closed circuit model and an open circuit model depending on the size of the pseudo-DC component obtained as an analysis result, and the transient analysis unit 3 performs a transient analysis corresponding to the classification result.

For example, when the transient analysis unit 3 obtains a time response in the inverse Fourier transform performed on a frequency response, it also can use a trapezoidal formula or a rectangular formula for a discrete integral equation.

In addition, for example, when the transient analysis unit 3 obtains a time response in the inverse Fourier transform performed on a frequency response, it also can idealize the time response by one impulse or two.

Furthermore, the model classification unit 5 can also classify an analysis model into: a closed circuit model when the pseudo-DC value is larger than the current value obtained by dividing by 1000 the value, which is obtained by dividing the voltage of 1 V by 377Ω, that is, an impedance of a free space; and an open circuit model when it is smaller than the current value.

When the model classification unit 5 classifies an analysis model into an open circuit model, the transient analysis unit 3 can further comprises: a pulse column adjustment unit 6 for removing an impulse smaller than a threshold from an impulse column forming an impulse response as a time response for the analysis model; and a high band amendment unit 7 for amending an output of the pulse column adjustment unit to prevent high band oscillation. The transient analysis unit 3 can further comprise: a time causality adjustment unit 8 for obtaining a time delay due to the transmission speed of a light from the time of inputting a signal for a time response, and adjusting the time response for consistency with time delay; and an unbalanced DC component adjustment unit 9 for removing from the time response an unbalanced DC component generated as an error in analyzing an open circuit model.

On the other hand, when the model classification unit 5 classifies an analysis model into a closed circuit model, the transient analysis unit 3 comprises a DC component removal unit 10 for removing a DC component from the time response obtained by performing an inverse Fourier transform on a frequency response. It also can comprise a pulse column adjustment unit 11 for obtaining a threshold from an impulse column as an output of the DC component removal unit 10, and removing an impulse smaller than the threshold. It can further comprise a window function application unit 12 for applying a window function for removal of a high band with the position of the largest impulse defined as the center of the impulse column to the output of the pulse column adjustment unit 11.

For example, when an analysis model is classified into a closed circuit model, the transient analysis unit 3 can comprise: a high band amendment unit 13 for amending an impulse response as a time response from which a DC component has been removed to prevent high band oscillation; a time causality adjustment unit 14 for obtaining a time delay due to the transmission speed of a light from a signal input point for an impulse response as a time response from which a DC component has been removed, and adjusting the time response for consistency with the time delay; and an unbalanced DC component adjustment unit 15 for removing from the time response an unbalanced DC component generated as an error in analyzing a closed circuit model before adding again the removed DC component.

In the method of computing the electromagnetic field intensity, the range of the analytic frequency used in the analysis in the moment method in a frequency domain corresponding to the analysis condition of the intensity of the electromagnetic field from an electric circuit device containing a nonlinear element is limited such that the range of the analytic frequency can be the range of those up to the frequency having the value nearest to the smallest value of the analytic frequency in the frequencies having a real part of 0 in the frequency response obtained as a result of the impulse response for an analysis model of the electric circuit device. The transient analysis is performed corresponding to the analytic frequency in the limited range.

In the method of computing the electromagnetic field intensity, a pseudo-DC analysis is performed on an analysis model of the electric circuit device containing a nonlinear element as an analysis in the moment method at an ultra low frequency in the frequencies to which the moment method can be applied. The analysis model is classified into a closed circuit model and an open circuit model depending on the size of the pseudo-DC component obtained as an analysis result, and a transient analysis is performed on the analysis model corresponding to a classification result.

At this time, for example, the DC component is removed from the time response obtained by performing an inverse Fourier transform on the frequency response to the closed circuit model in the transient analysis, a threshold is obtained from an impulse column from which a DC component has been removed, and an impulse smaller than the threshold is removed from the impulse column.

The present invention also includes a computer-readable portable storage medium storing a program used to direct a computer to perform the steps of: limiting the range of the analytic frequency used in the analysis in the moment method in a frequency domain corresponding to the analysis condition of the intensity of the electromagnetic field from an electric circuit device containing a nonlinear element such that the range of the analytic frequency can be the range of those up to the frequency having the value nearest to the smallest value of the analytic frequency in the frequencies having a real part of 0 in the frequency response obtained as a result of the impulse response for an analysis model of the electric circuit device; and performing the transient analysis corresponding to the analytic frequency in the limited range.

The present invention also includes a computer-readable portable storage medium storing a program used to direct a computer to perform the steps of: performing a pseudo-DC analysis on an analysis model of the electric circuit device containing a nonlinear element as an analysis in the moment method at an ultra low frequency in the frequencies to which the moment method can be applied; classifying the analysis model into a closed circuit model and an open circuit model depending on the size of the pseudo-DC component obtained as an analysis result; and performing a transient analysis on the analysis model corresponding to a classification result.

The electromagnetic field intensity computation apparatus 1 for computing the intensity of the electromagnetic field from an electric circuit device further comprises a display instruction input unit 16 for receiving from a user an instruction to stepwise and automatically change a result display scale and a display unit when an analysis result is displayed for the electric circuit device.

For example, a displayed analysis result can be a waveform viewer, an electromagnetic flow vector, an input impulse, or the distribution of an electromagnetic flow.

In addition, the present invention can also includes, when an analysis result of the electromagnetic field intensity related to an electric circuit device is displayed, a computer-readable portable storage medium storing a program used to direct a computer to perform the steps of: receiving from a user an instruction to stepwise and automatically change a result display scale and a display unit; and displaying an analysis result depending on the contents of the instruction.

As described above, the range of the analytic frequency used in the moment method is limited. As a result of a pseudo-DC analysis, an analysis model is classified into a closed circuit model and an open circuit model, and a transient analysis is performed corresponding to a classification result. Furthermore, when an analysis result is displayed, a result display scale and a display unit are stepwise and automatically changed. Detailed explanation is described below.

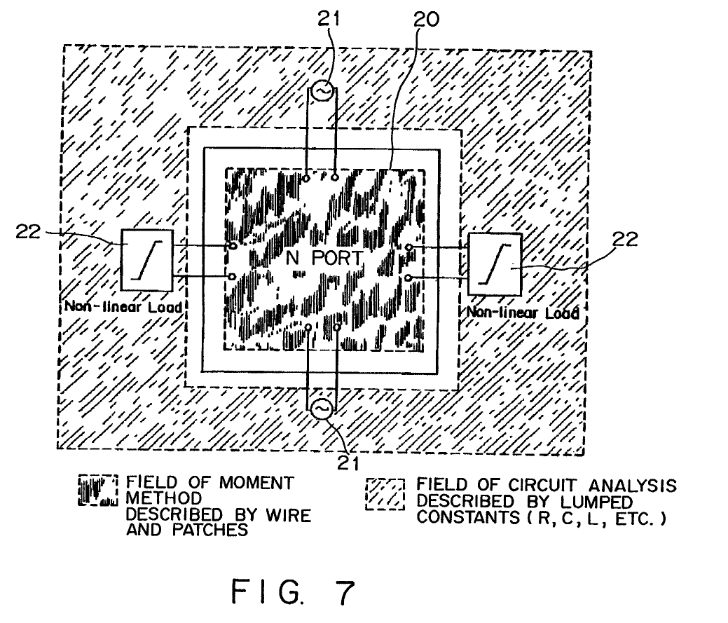

FIG. 7 shows the concept of the electromagnetic field intensity computation system according to the present invention. According to this aspect, the intensity of the electromagnetic field from a electric circuit device containing a nonlinear element can be computed by combining the moment method with the circuit analysis.

An enclosure 20 of the electric circuit device shown at the center of FIG. 7 is, for example, divided into small patches on which an analysis is performed in the moment method. The enclosure 20 is normally provided with a plurality of ports (N port) to some of which a voltage source (wave source) 21 is connected. To other ports, for example, a nonlinear load 22 having a saturation characteristic is connected.

The enclosure 20 at the center is described with the above mentioned patches and wire, and analyzed in the moment method. On the other hand, the voltage source 21 and the nonlinear load 22 belongs to the circuit analysis described by, for example, a lumped constant (R, C, L, etc.), and the electromagnetic field intensity can be computed by combining the moment method with the circuit analysis.

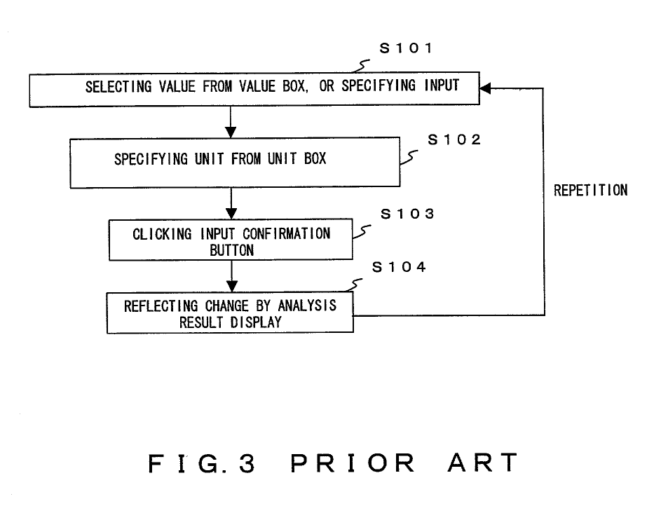

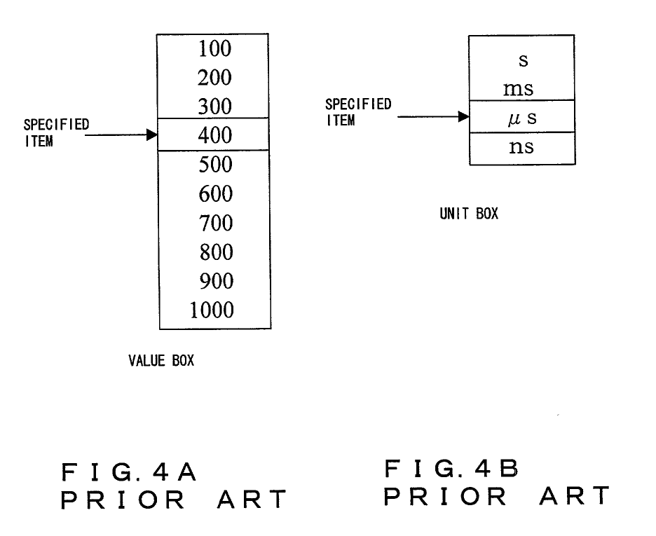

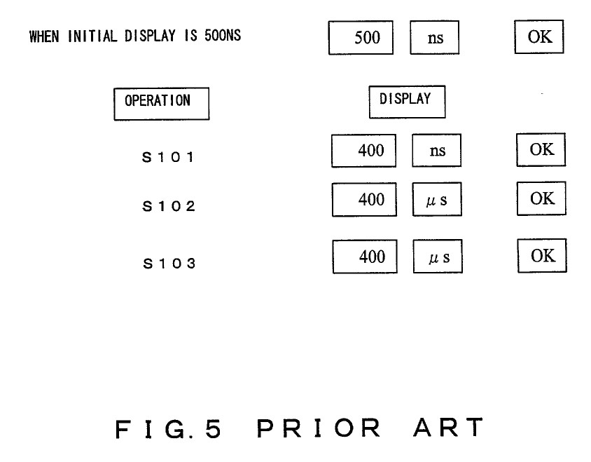

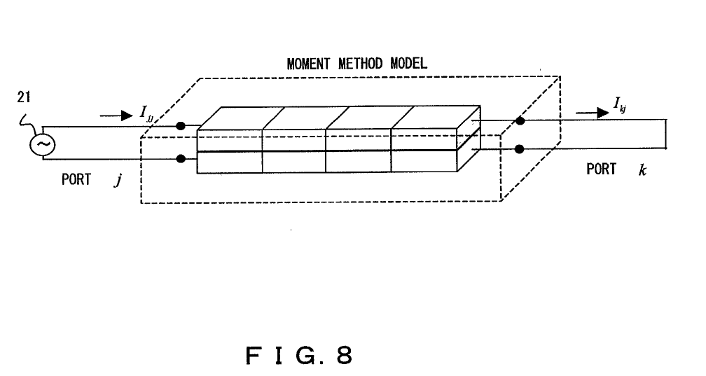

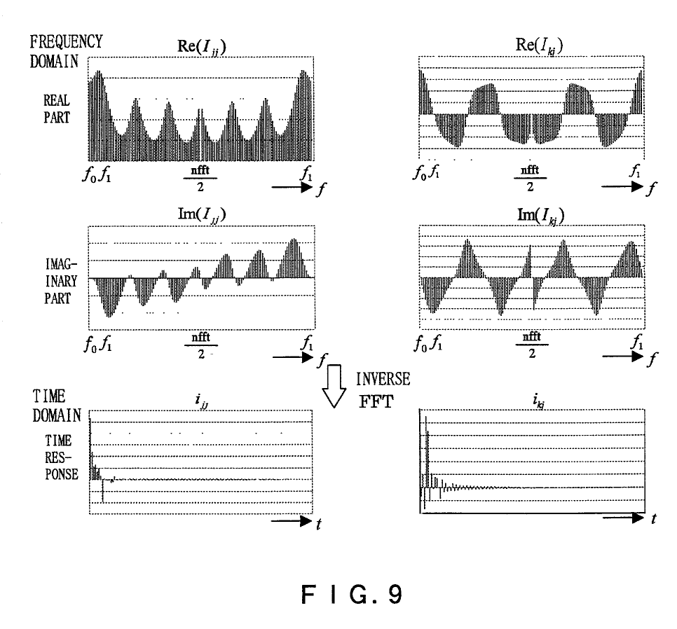

FIG. 8 shows a model for combination of the moment method with the circuit analysis. FIG. 9 shows the method for obtaining a time response in the fast inverse Fourier transform (inverse FFT) performed on the frequency response obtained in the moment method. In FIG. 3, in the above mentioned plurality of (N) ports, the voltage source (wave source) 21 is connected to the j-th (j=1, 2, . . . , N) port, and a current flows through the k-th port (for example, short-circuited) through the casing described for the model in the moment method. At this time, the current flowing through the j-th port is Iⱼⱼ, and the current flowing through the k-th port is Iₖⱼ.

In the frequency domain, an analysis is performed on the fundamental frequency fl and a half of the “number nfft of analytic frequencies” nfft described later, that is, the higher harmonics of fl up to the nfft/2-th as analytic frequencies. At this time, the voltage of the wave source 21 applied to the j-th port is 1V.

In FIG. 9, the real part and the imaginary part of the Iⱼⱼ and Iₖⱼ indicating the frequency response are obtained by the analysis of the frequency domain as described later from the fundamental frequency f₁ to the nfft/2-th analytic frequency. Then, the previously obtained value for each analytic frequency is used as a loopback computation result for the real part of the Iⱼⱼ and Iₖⱼ, and the value obtained by inverting the sign is used for each imaginary part, thereby terminating the analysis in the frequency domain. Then, by performing an inverse Fourier transform on the analysis result of the obtained frequency domain, the response of a time domain, that is, the time response, can be obtained as the current Iⱼⱼ and Iₖⱼ.

Using the obtained impulse response, the current ik(t) flowing through the k-th port when an arbitrary voltage waveform vj (t) is applied to the j-th port is expressed by the following equation (g indicates an impulse response).

$${i}_{k} ( t ) {\sum }_{j = 1}^{N} {\int }_{0}^{t} {i}_{gkj} ( t - τ ) {v}_{j} ( τ ) ⅆ τ \qquad ( 1 )$$

k =1,2 . .. ,N

For discreteness with the time t set as t=qΔt, the current flowing through the k-th port at the time t=qΔt is expressed by the following equation.

$${i}_{k}^{( q )} ( t ) = {\sum }_{j = 1}^{N} {i}_{gkj}^{( 0 )} {v}^{( q )} Δ t + {\sum }_{j = 1}^{N} {\sum }_{p = 0}^{q - 1} {i}_{gkj}^{( q - p )} {v}^{( p )} Δ t \qquad ( 2 )$$

k=1,2, . . . , N

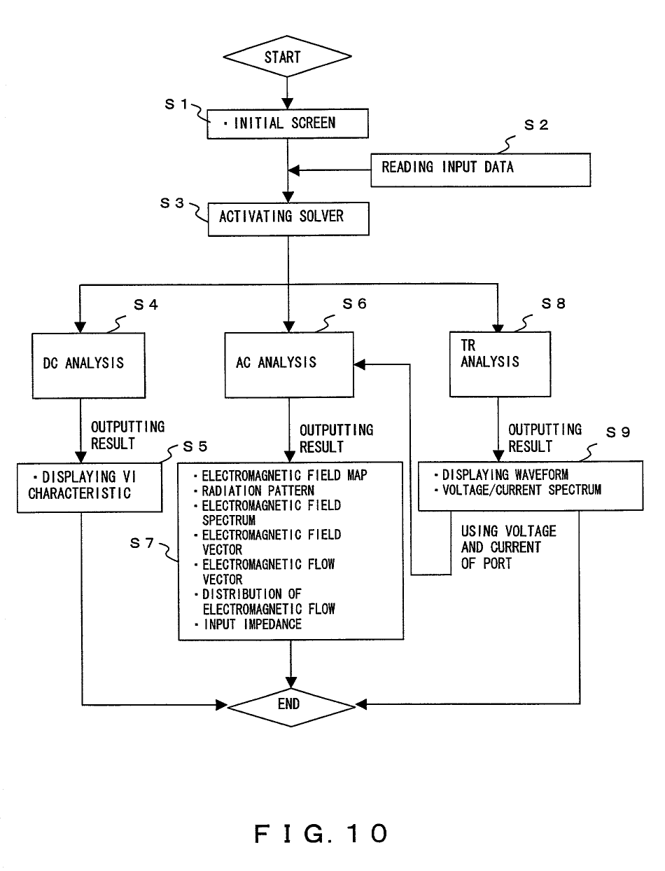

FIG. 10 is a flowchart of the entire process of the electromagnetic field intensity computation apparatus. In FIG. 10, when the process is started, the initial screen is first displayed in step S1, and input data such as the fundamental analytic frequency f1, etc. in the above mentioned moment method is read in step S2. In step S3, a solver, that is, the electromagnetic field intensity computation apparatus, is activated, and it is determined whether the request from the user is a direct current (DC) analysis, an alternating current (AC) analysis, or a transient (TR) analysis. If the user requests the DC analysis, it is performed in step S4. In step S5, for example, the VI characteristic of a semiconductor diode is displayed, thereby terminating the process.

If the user requests the AC analysis, it is performed in step S6. In step S7, an electromagnetic field, a radiation pattern, an electromagnetic field spectrum, an electromagnetic field vector, an electromagnetic flow vector, the distribution of an electromagnetic flow, an input impedance, etc. are output as analysis results, thereby terminating the process. In the AC analysis in step S6, the voltage and the current of a port normally obtained as a result of the transient analysis are used.

When the user request is a TR analysis, it is performed in step S8, and the analysis result is output as the display of the voltage and the current waveform, or as the display of the voltage or a current spectrum in step S9, thereby terminating the process and, as described above, transmitting the result to the AC analysis in step S6 as necessary.

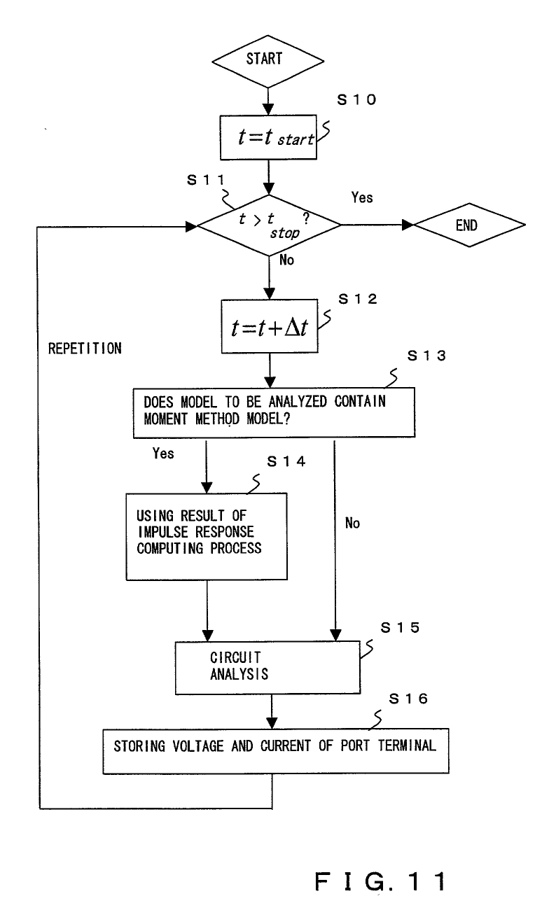

The feature of the present invention resides in the process performed when the model to be analyzed in the transient analysis in step S8 contains a moment method model. To describe the process, the flowchart shown in FIG. 11 of the entire process of the TR analysis in step S8 is first described as follows.

In FIG. 11, when the process is started, the value of the time t is set to the value of the computation starting time tstart in step S10. In step S1, it is determined whether or not the time t has exceeded the computation terminating time tₛₜₒₚ. If yes, the process immediately terminates.

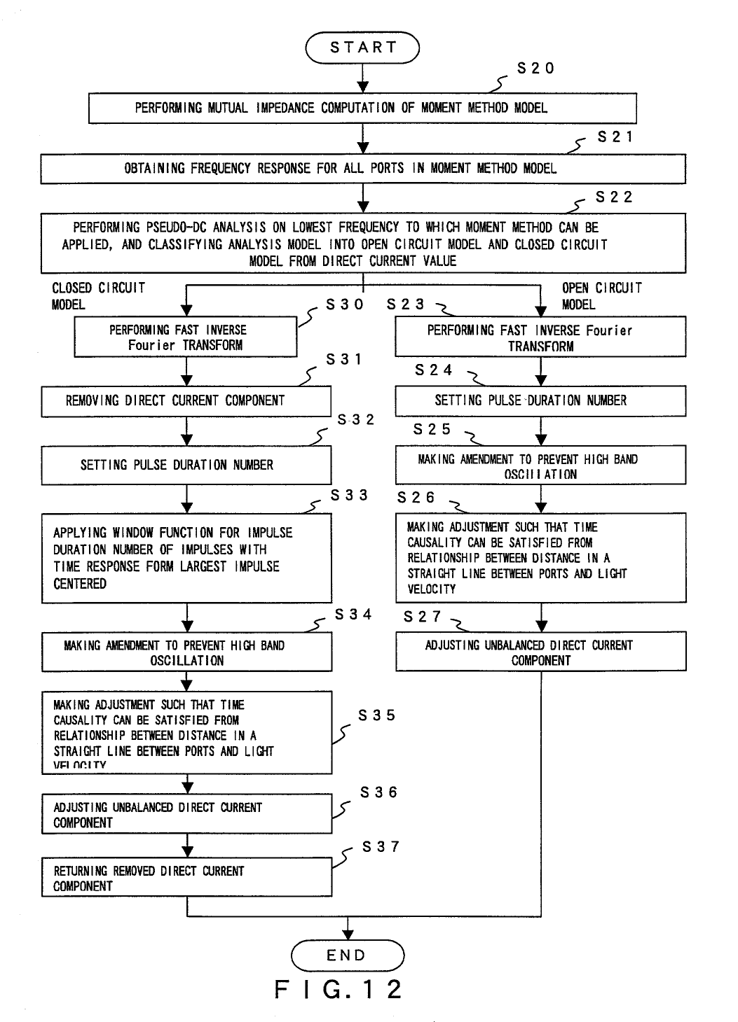

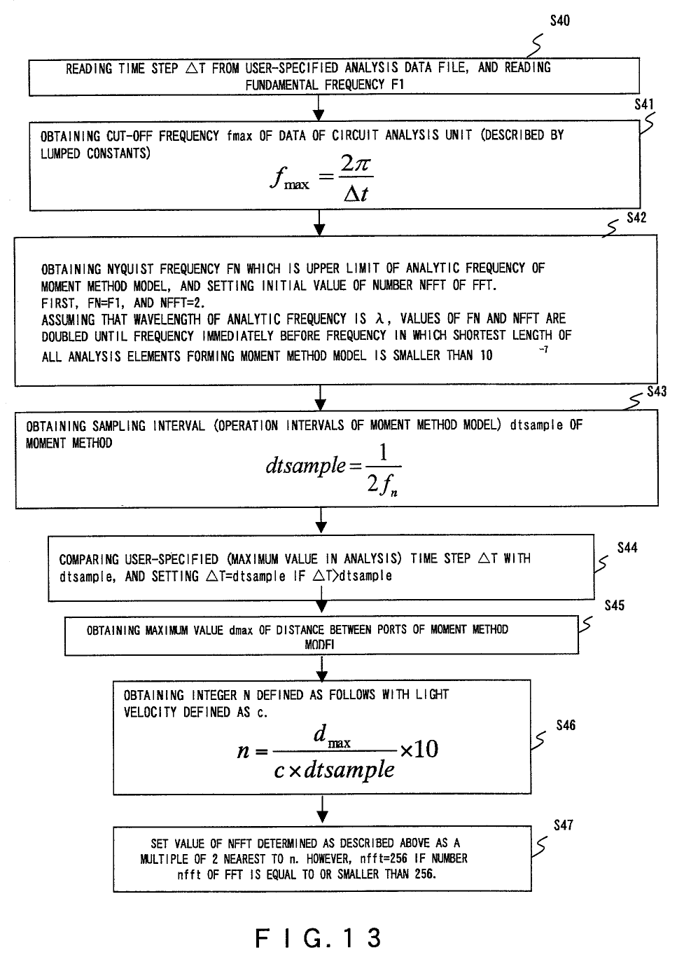

If the value of the time t is smaller than the value of the computation terminating time tₛₜₒₚ, then the value of the time t is incremented by Δt in step S12, and it is determined in step S13 whether or not the model to be analyzed contains a moment method model. If yes, the result of the impulse response computing process shown in FIG. 12 is used, and the circuit is analyzed in step S15.

If it is determined in step S13 that the moment method model is not contained, the circuit is analyzed in step S15 without using the result of the impulse response computing process in step S14. In this circuit analysis, a common node analysis, a cut-set analysis, a hybrid analysis, etc. are performed. As a result of the circuit analysis, the values of the terminal voltage and current of a port are stored in step S16, and the processes in and after step S11 are repeated.

FIG. 12 is a detailed flowchart of the impulse response computing process. In FIG. 12, when the process is started, impedance computation is performed on a moment method model in step S20, that is, the impedance computation is performed on patches when, for example, an enclosure, etc. is divided into small patches. In step S21, the frequency responses of the current flowing through a port to which a wave source is connected, and the current flowing through other ports are obtained for all ports in the moment method model. The analytic frequency for which a frequency response is to be obtained is determined before the activation of the solver in step S3 shown in FIG. 10, and provided for the solver, but the determining method is described later.

In step S21, the analytic frequencies for practical computation are limited among the determined analytic frequencies as described later to considerably reduce the amount of computation required in computing the impulse response as described later.

In step S22, the moment method analysis for the lowest frequency to which the moment method can be applied is performed as a pseudo-DC analysis, and the moment method is classified into an open circuit model, that is, a model such as an antenna, etc. and a closed circuit model, that is, a model such as a transmission line, etc. depending on the pseudo-DC value obtained in the DC analysis. Normally, a direct current does not fundamentally flow through an open circuit model such as an antenna, etc. while a direct current of a certain intensity flows through a closed circuit model such as a transmission line, etc. Therefore, it can be defined that a model is an open circuit model when a direct current is nearly 0, and a closed circuit model when a direct current is large to a certain extent. However, as a practical determination standard, for example, an open circuit model can be determined when a direct current value is smaller than 1/1000 of the value obtained by dividing the voltage of 1 V by 377Ω, that is, the impedance value of a free space, and a closed circuit model can be determined when it is lager.

Described below is the frequency for the pseudo-DC analysis performed in step S22, that is, the lowest frequency to which the moment method can be applied. As described later, the analytic frequencies in the moment method can be the frequencies in the range from the user-specified fundamental frequency fl to the Nyquist frequency fn as the upper limit of the analytic frequency which is the higher harmonics of f1. The fundamental frequency is, for example, 5 MHz, and the Nyquist frequency if fn=2.56 GHz. The pseudo-DC analysis is normally performed at a frequency much lower than the fundamental frequency f1.

The computation in the moment method has to be performed on the premise effective for the computation. The premise of the computation in the moment method is that it is performed only on the analytic frequencies when the lengths of all analysis elements forming a moment method model, that is, the patches and wire, are larger than 10⁻⁷λ and smaller than 0.25λ where the wavelength of the analytic frequency is λ. The premise corresponds to an embodiment of the present invention, but does not mean that the range is limited to the above mentioned values.

When the frequency is lower, the wavelength λ becomes larger. Therefore, in the above mentioned range, a frequency is limited to the range in which the lengths of all analysis elements are smaller than the larger limit, that is, 0.25 λ. Then, the range of the analytic frequency is limited such that the length of the longest analysis element in all analysis elements can be shorter than 0.25 λ.

Assume that the electric length of the longest element in all analysis elements is L, and the frequency is f. The wavelength λ is obtained by dividing light velocity C by a frequency f. Therefore, when the frequency f becomes lower, the following equation is satisfied if the frequency f is in the applicable range of the moment method.

L≦0.25λ=0.25×C/f (3)

Assuming that the fundamental frequency f1 obviously satisfies the equation above, it is repeatedly determined whether or not the equation above is satisfied with the value first set to f1 and then with the value of the frequency halved. When the frequency reaches the value which does not satisfy the equation above, the frequency immediately before can be defined as the lowest frequency to which the moment method can be applied. Using the frequency, the pseudo-DC analysis is performed.

When a model is classified into an open circuit model, a fast inverse Fourier transform is performed on a frequency response in step S23, and a time response is fundamentally obtained as a transform result. The processes in steps S24 through S27 are performed on an obtained impulse response.

In step S24, a pulse duration number (pulse duration number refers to the number of continuous impulses at predetermined time intervals) described later is set. Then, in step S25, an amendment is made to prevent high band oscillation as a process of stabilizing an impulse response. The amendment is described later in detail.

Then, in step S26, an adjusting process is performed to satisfy the time causality. In this process, considering the relationship between the straight line between ports and the light velocity, a time from a point when a wave source is applied to, for example, the j-th port, to a point when a response is output to the k-th port is obtained. If an output is detected as a time response before the time period, the output is regarded as invalid, and an adjusting process is performed.

Then, in step S27, an unbalanced direct current component is adjusted. As described above, an open circuit model is a model through which a direct current does not flow. If a direct current component is detected as a result of the processes in steps S23 through S26, then the component, that is, an unbalanced direct current component, is removed, thereby terminating the impulse response computing process.

When a model to be analyzed is classified into a closed circuit model in step S22, a fast inverse Fourier transform is similarly performed in step S30 as in step S23, thereby obtaining a fundamental time response. Then, in step S31, a direct current component is removed from the time response. Since the direct current component is large to a certain extent, the direct current component interfering with the processes in and after step S32 is removed from the time response in advance.

Then, in step S32, as in step S24, the pulse retention number is set. However, the process is partly different from the process performed on an open circuit model. In this pulse duration number setting process, a pulse having a value smaller than a threshold is removed from an impulse column, and, as a result, it is detected how many pulses form the impulse column, thereby setting the pulse duration number.

In step S33, the application of a window function is centered on the time of the impulse having the largest value as the result of removing the impulse smaller than the threshold from the impulse column. The window function is used to stabilize a high band, and, for example, a Blackman window is used. The Blackman window is described in the following document.

[Document 2] Ishida and Kamata: Point of Digital Signal Process, P194, Industrial Library (1989).

Then, in steps S34 through S36, the processes in steps S25 through S27 on an open circuit model, that is, an amendment to prevent a high band oscillation, an adjustment to satisfy the time causality, and an adjustment of unbalanced direct current component, are performed, and finally, the direct current component removed in step S31 is restored in step S37. That is, the direct current component is added again, thereby terminating the process of obtaining an impulse response.

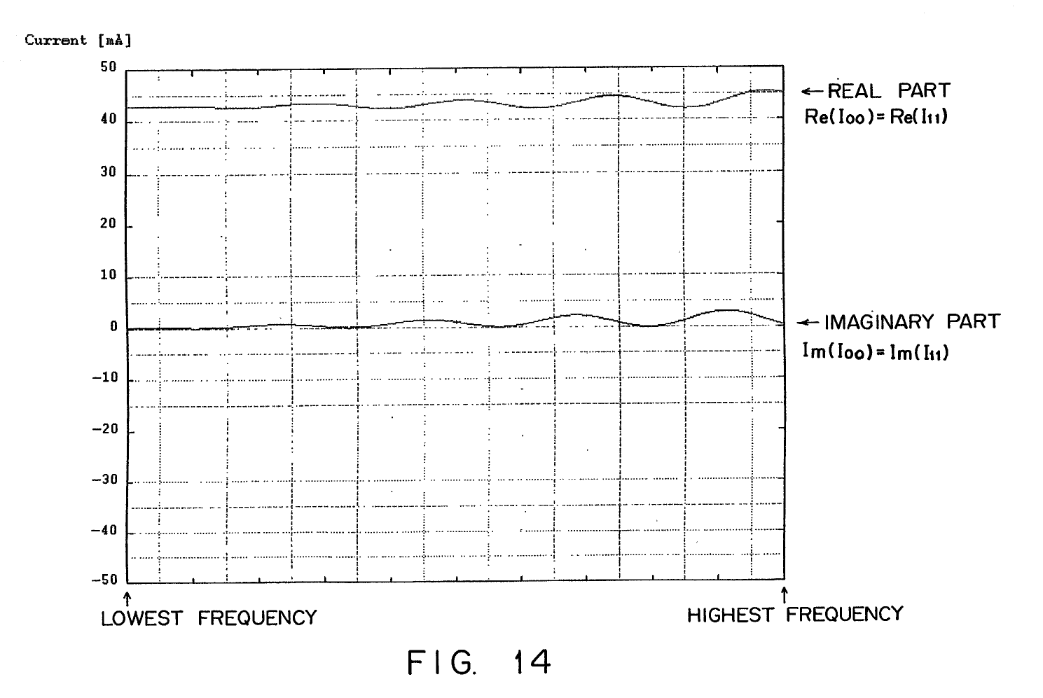

FIG. 13 is a detailed flowchart of the method of determining the number of analytic frequencies used in the analysis in the moment method in a frequency domain. The process in FIG. 13 is performed before activating the solver in step S3 shown in FIG. 10.

When the process is started as shown in FIG. 13, the time step Δt used in step S12 shown in FIG. 11 and the value of f1 as a fundamental frequency in the moment method are read from the analysis data file specified by the user in step S40. Then, in step S41, the cut-off frequency fmax fundamentally as the data of the circuit analysis unit is obtained using the value of the time step Δt.

Then, in step S42, the Nyquist frequency fn as an upper limit of the analytic frequency of the moment method model, and the number of analytic frequencies in the moment method, that is, the number nfft of the frequencies in a fast Fourier transform, are obtained. First in this process, the fundamental frequency f1 is set as the initial value of fn, and 2 is set as the initial value of the number nfft of analytic frequencies, thereby starting the process. In this step S42, since the Nyquist frequency fn is obtained by increasing the fundamental frequency f1 to the power of 2, the process of doubling the values of fn and nfft from the initial values is repeated. According to the present embodiment, the process is repeated until the frequency immediately before the frequency whose value is in the range of the fmax obtained in step S41, and is the shortest in all analysis elements forming the moment method models, for example, smaller than 10⁻⁷λ in length of a patch edge, can be obtained. λ indicates a wavelength for the analytic frequency. When the analytic frequency becomes high in the moment method, and the length of the smallest analysis element is shorter than 10⁻⁷λ, the premise of the moment method is not satisfied. Therefore, the value of the Nyquist frequency fn is limited to the above mentioned the range.

Then, in step S43, the sampling interval in the moment method, that is, the value of the operation cycle dtsample for a moment method model, is obtained as ½ fn. In step S44, the value is compared with the user-specified time step AΔ. If the value of Δt is larger, then Δt is amended such that it can match the sampling interval. That is, the value of Δt is specified by a user, but the actual computation can be normally performed at shorter intervals. When the value of dtsample is smaller, a smaller value is set for At for use in the computation.

In step S45, the maximum value of the distance between the ports of the moment method models, that is, the maximum distance dₘₐₓ of the distance between the ports, is obtained when there are a plurality of ports, and the value of the integer n defined by the following equation is obtained in step S46.

$$n = \frac{{d}_{max}}{c \times {dt}_{sample}} \times 10 \qquad ( 4 )$$

The meaning of n is described below. That is, the signal propagation time for the distance between the ports can be obtained by dividing the maximum distance between the ports by the light velocity C. By further dividing the obtained value by the sampling interval, the times of the operations of the process in the moment method within the propagation time can be obtained. n is defined as a value obtained by multiplying the result by 10. The value of 10 is used to determine the sufficient number of analytic frequencies in the next step S47 by multiplying the maximum value of the distance between the port by 10, and setting sufficient distance to suppress the reflection in a transmission line.

Finally, in step S47, the number nfft of analytic frequencies is set as a multiple of 2 nearest to the value n determined in step S46 within the range determined in step S42, thereby terminating the process. When the value of nfft is equal to or smaller than 256, there arises the problem in computation precision if the number of analytic frequencies is too small, thereby terminating the process by setting the value to 256 according to the present embodiment.

Described below is the restriction on the number of analytic frequencies to reduce the amount of computation for the simultaneous equations in the moment method in the present embodiment. As shown in FIG. 13, the analytic frequency is a fundamental frequency f1 and higher harmonics, and the number of frequencies is nfft. According to the present embodiment, in a total of nfft analytic frequencies, only the analytic frequency nearest to the fundamental frequency f1 is used.

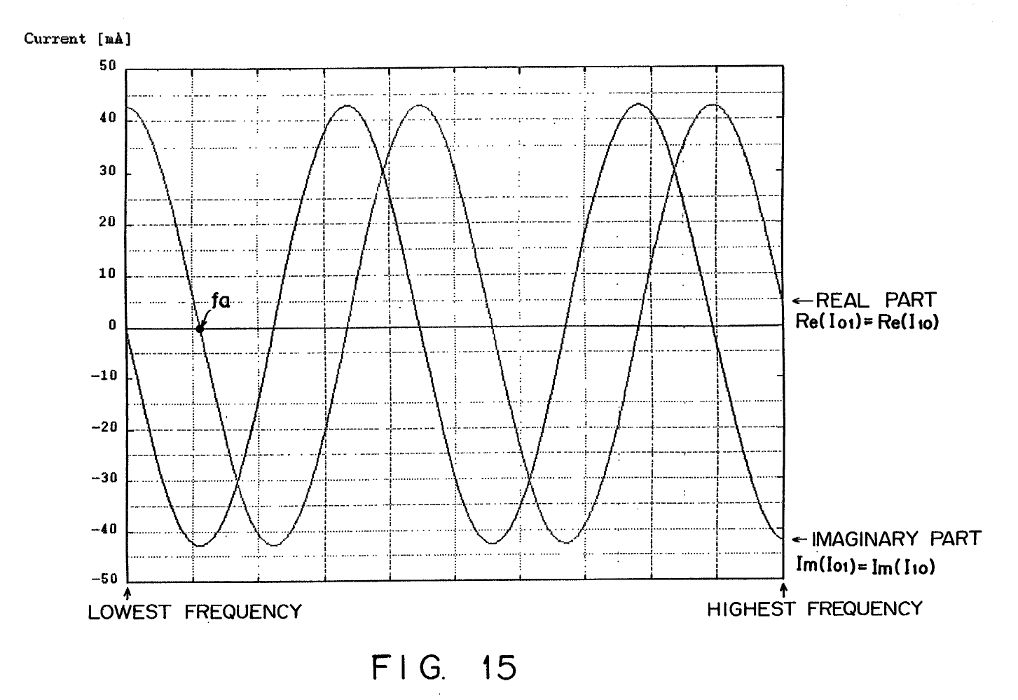

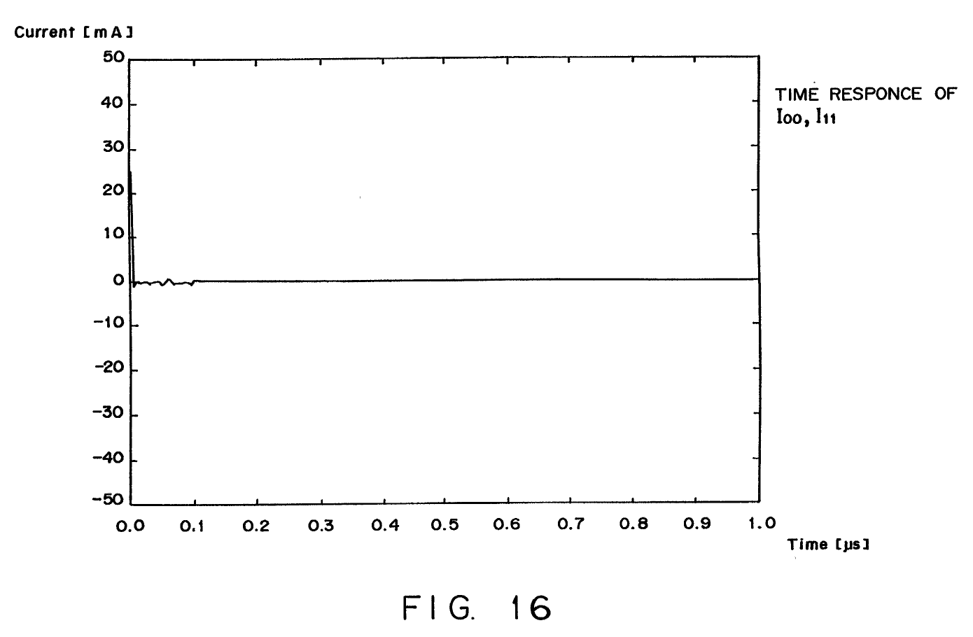

FIGS. 14 and 15 show the real parts and the imaginary parts of frequency responses for the lowest analysis frequency, that is, the fundamental frequency f1, through the highest frequency, that is, the nfft-th frequency. FIGS. 14 and 15 show the frequency responses of the electric currents using symmetrical transmission lines between two ports, the frequency response of a current flowing when a wave source is connected to one of the two ports, and a matching resistance, that is, a resistance having a value near the characteristic impedance is connected to the other port. Ioo indicates a current flowing through the 0-th port when a wave source is connected to the port. I01 indicates a current flowing through the first port when a wave source is connected to the 0-th port. I10 and Ill indicate the similar meanings. Obviously, between I00 and I11, the real parts match each other, and the imaginary parts match each other. Similarly, between I01 and I10, the real parts match each other, and the imaginary parts match each other.

In FIG. 14, the current flowing through the port to which the wave source is connected has a real part larger than an imaginary part.

On the other hand, as shown in FIG. 15, the current flowing through a port when a voltage of 1 v is applied as a wave source to the other port, that is, the real part and the imaginary part of a frequency response as a result of an impulse response, changes for an analytic frequency in a sine wave. The real part corresponds to a cosine function, and the imaginary part corresponds to a sine function. When computation is performed by simultaneous equations in the moment method on the frequency down to fa as the lowest frequency at which the real part crosses the horizontal axis, the result can be used for the higher analytic frequencies. When there are three or more ports, a plurality of frequency responses can be obtained as shown in FIG. 15. However, the computation can be performed up to the largest value in the obtained values of fa.

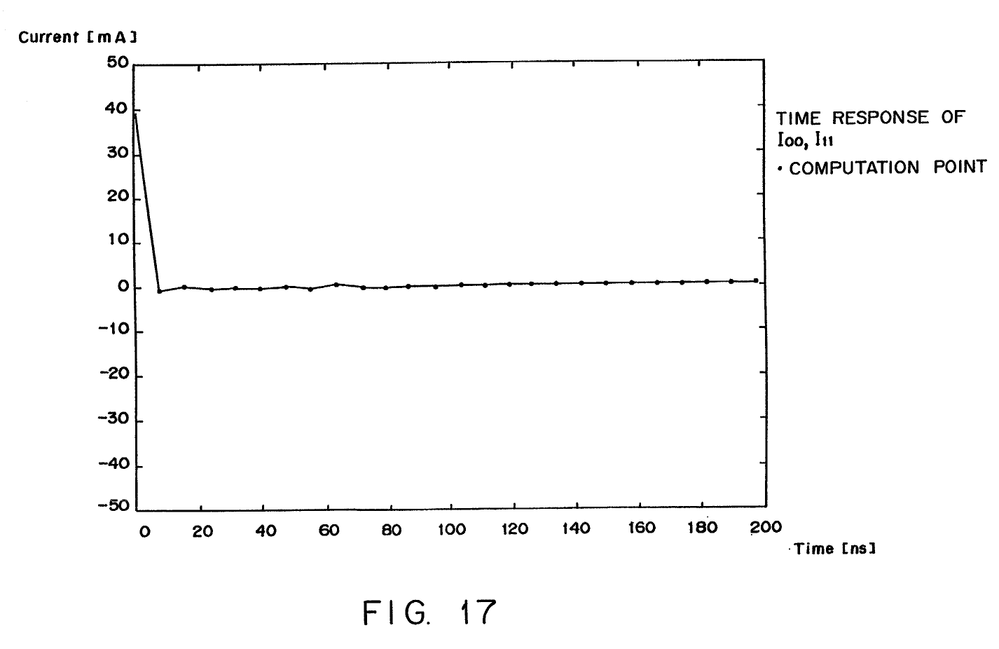

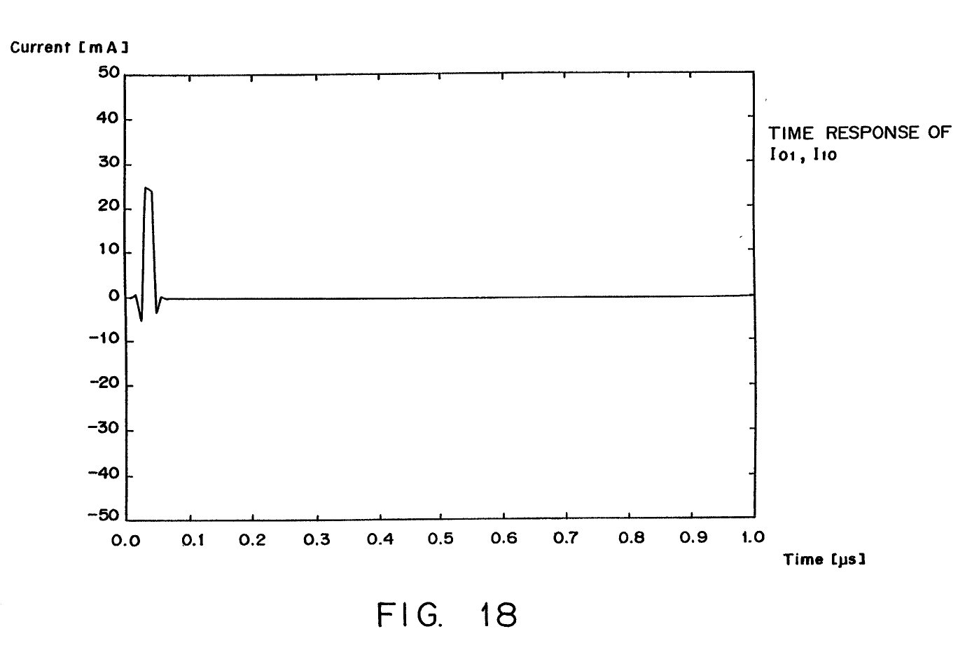

FIGS. 16 through 19 show examples of time responses as results of an inverse Fourier transform of the frequency response as shown in FIG. 15. FIG. 11 shows a time response as a result of an inverse Fourier transform on the frequency responses I00 and I11. FIG. 17 is an enlarged view of the initial portion of the response.

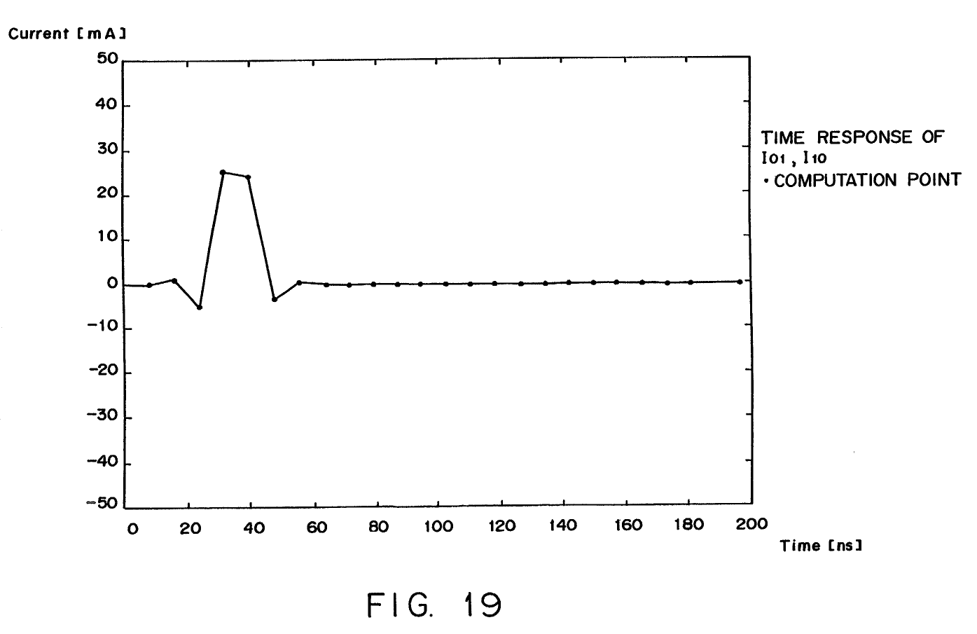

FIG. 18 shows a time response as an inverse Fourier transform of the frequency response I01 and I10, and FIG. 19 is its enlarged view. In these figures, the time response is obtained as fundamentally a positive or negative impulse column. However, these figures show the time responses as waveforms containing the peaks of impulses.

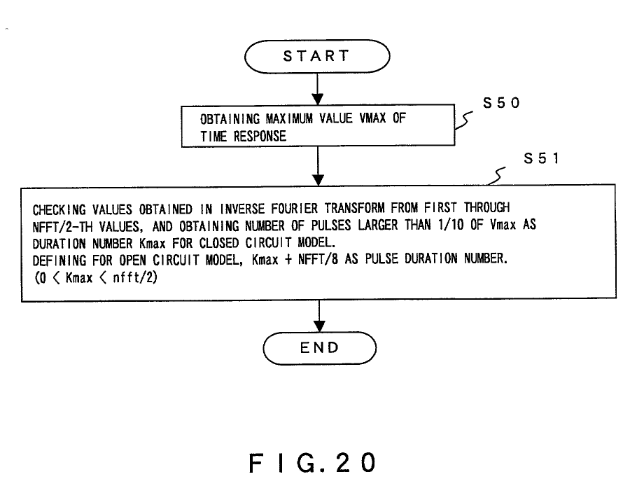

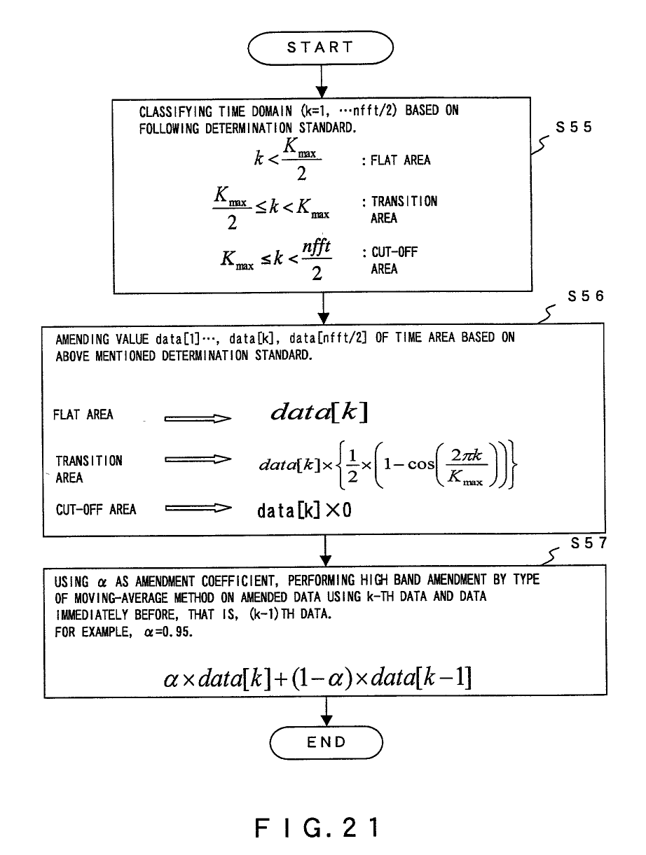

FIG. 20 is a flowchart of the pulse duration number setting process described in steps S24 and S32 by referring to FIG. 12. In FIG. 12, when the process is started, the peak value Vmax of the impulse having the largest peak value in the impulse column as a time response is obtained in step S50.

Then, in step S51, assuming that 1/10 of the largest value Vmax is a threshold, an impulse larger than the threshold is searched for. According to the present embodiment, since the impulse column of an impulse response exists at a time not far from the time t=0 at which an impulse is applied on the wave source side, an impulse having a value larger than the threshold is searched for in the impulse column corresponding to the computation time for the first through the nfft/2-th impulses in the impulse columns. The computation times obtained by an inverse Fourier transform respectively correspond to nfft analytic frequencies of the frequency responses. Only the first half of them are checked, and the number of impulses having values larger than the threshold is obtained as the pulse duration number Kmax for a closed circuit model.

The pulse duration number for an open circuit model is set to the value of Kmax+nfft/8. For an open circuit model such as an antenna model, etc., it is difficult to obtain a matching value on the reception side, and a value of, for example, nfft/8 is added in consideration of the reflection continuing for some time.

FIG. 21 is a detailed flowchart of the high band oscillation preventing process for the closed circuit model described in step S34 shown in FIG. 12. In FIG. 21, when the process is started, the first half time domain in the above mentioned nfft computation times is classified into a flat area, a transient area, and a cut-off area in step S55. That is, using the pulse duration number Kmax, the time domain from the starting time to the time Kmax/2 is defined as the flat area, the time domain from Kmax/2 to Kmax is defined as a transition area, and the time domain from Kmax to nfft/2 is defined as a cut-off area.

Then, in step S56, the data, that is, the values of impulses, in the flat area is kept as is. The peak value of the impulse is 0 for the cut-off area. Multiplication by a coefficient which is expressed by ½×[1-cos(2πk/Kmax)], that is, a value nearly equal to 1 at an initial point in the transition area and a value nearly equal to 0 at a point near the cut-off area, is performed for the transition area. The coefficient is a kind of filter, and is effective in suppressing the high band oscillation.

For example, if the value of Kmax is 100, the transition area refers to the area from the 50th through 100th computation time points. The values of the coefficients by which the data is multiplied approaches 1 as the value of k approaches 50, and the coefficient approaches 0 as the value of k approaches 100. That is, at the point nearer to the flat area, the data can be used as is. At the point nearer to the cut-off area, data is amended for smaller value using, for example, a filter corresponding to a Hann window function.

When the data is completely amended, a high band is amended by the technology of the moving-average method in step S57. In this process, a value computed by the following equation as the k-th data amended in step S56 is adopted using the amendment coefficient α for stability. The value of α is, for example, 0.95 according to the present embodiment.

α×data[k]+(1-α)×data[k -1] (5)

In the moving-average method, when the time response is obtained as a result of an inverse Fourier transform after obtaining a frequency response, the time response contains a higher harmonics component with low precision. Therefore, the higher harmonics component is cut by a low pass filter for a high band amendment. That is, in a discrete time series in which frequent changes are detected, it is desired that a higher harmonics component is removed in advance using a low pass filter. Especially when only a low frequency component in a large volume of data is to be checked, the long series is not directly processed in the FFT, but a moving-average is commonly obtained. In this moving-average method, time-series data is shifted in order, and a moving-average is obtained for every p sequences of data. The computing time in the data process can be shortened not only by cutting a higher harmonics component of a signal, but also by thinning out a sample value.

In step S25 shown in FIG. 12, that is, in the amending process for preventing high band oscillation of an open circuit model, the same process using Kmax+nfft/8 instead of Kmax as the pulse duration number as in steps S55 through S57 shown in 21 is performed.

The process of computing an impulse response as shown in FIG. 12 is described above. Finally, the process of idealizing an impulse column obtained by an inverse Fourier transform into only one impulse or two impulses is described below as an extreme example of a process of setting the pulse duration number and the limiting the number of pulses by removing impulses smaller than a threshold from an impulse column obtained as a result of the inverse Fourier transform of a frequency response. In this process, the above mentioned impulse retention number can be set to 1 or 2.

In the process of idealizing an impulse column into one impulse, an impulse having the largest value in the impulse column can be set as only one ideal impulse. On the other hand, when two ideal impulses are used, for example, the time response shown in FIG. 19 is connected using a smooth curve. At this time, the largest value of the time of the time response does not always match the computation time, and included in computation time. Therefore, there should be two impulses divided for the times before and after the computation time.

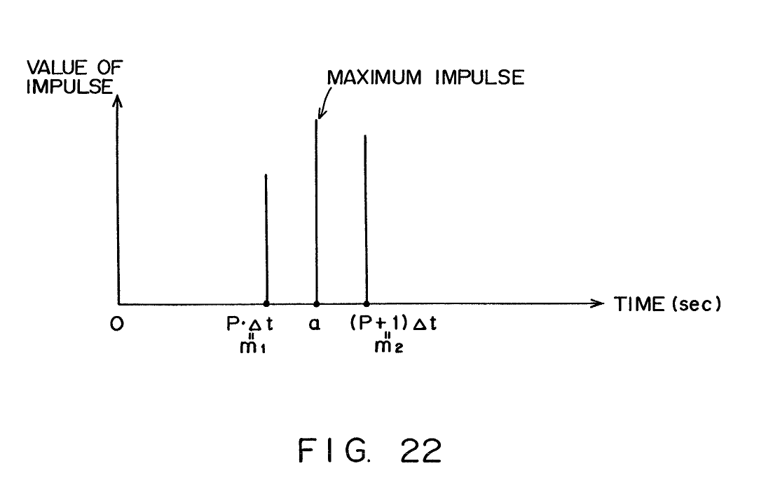

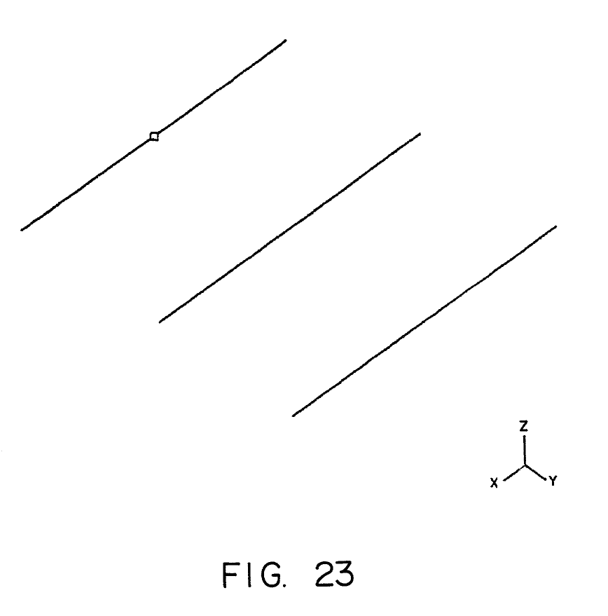

FIG. 22 shows the process of idealizing an impulse when the largest value of the time of the time response is set to a, and it is divided into the computation times before and after the time a, that is, the impulses at each Δt.

In FIG. 22, the impulse at the time a (corresponding to the largest value of the time response) is idealized by the two impulses at the times m1 and m2 respectively corresponding to the time step Δt, of the computation specified by the user of the electromagnetic field intensity computation apparatus, multiplied by p, and by p+1.

In relation to the system of a Fourier transform, the process of idealizing the impulse having the peak value of A (corresponding to the above mentioned Vmax) at time a into the impulses having the peak values of M1 and M2 respectively at times m1 and m2 is expressed by the following equation as the relationship with the frequency domain, and the correlation among M1, M2, and A is applied to the time domain.

ae^{ax}≈M₁e^{m1x}+M₂e^{m2x} (6)

In the frequency domain, the value of A is provided as a direct current value in a pseudo-DC analysis. In FIG. 14, the real part and the imaginary part of the frequency response of a current flowing through the port to which a wave source is connected are shown in the range from the fundamental frequency as the lowest frequency to the Nyquist frequency as the highest frequency. However, assuming that the range of the frequency is extended to left to the frequency in the pseudo-DC analysis, that is, to the ultra low frequency to which the moment method can be applied, the current value of the real part of the frequency response at the frequency is obtained as a pseudo-DC value, that is, the value of A.

The value at time a is provided by the following equation using the frequency fa described by referring to FIG. 15, that is, the frequency at which the real part of the frequency response is initially 0.

a=¼fₐ (7)

By dividing a by Δt, the values of p and p+1 corresponding to the times of the impulses before and after the impulse shown in FIG. 22 can be obtained, and the times of m1 and m2 can also be obtained.

Using the values of A, a, m1, and m2, the peak values M1 and M2 of the two impulses in the time area are obtained by the following equations.

$${M}_{1} = \frac{{m}_{2} - a}{{m}_{2} - {m}_{1}} A , {M}_{2} = \frac{a - {m}_{1}}{{m}_{2} - {m}_{1}} A \qquad ( 8 )$$

Described below are examples of computation results for the open circuit model and the closed circuit model according to the present invention. FIG. 23 shows a model of an antenna as an open circuit model. In FIG. 23, a model of a Yagi antenna having three elements is shown.

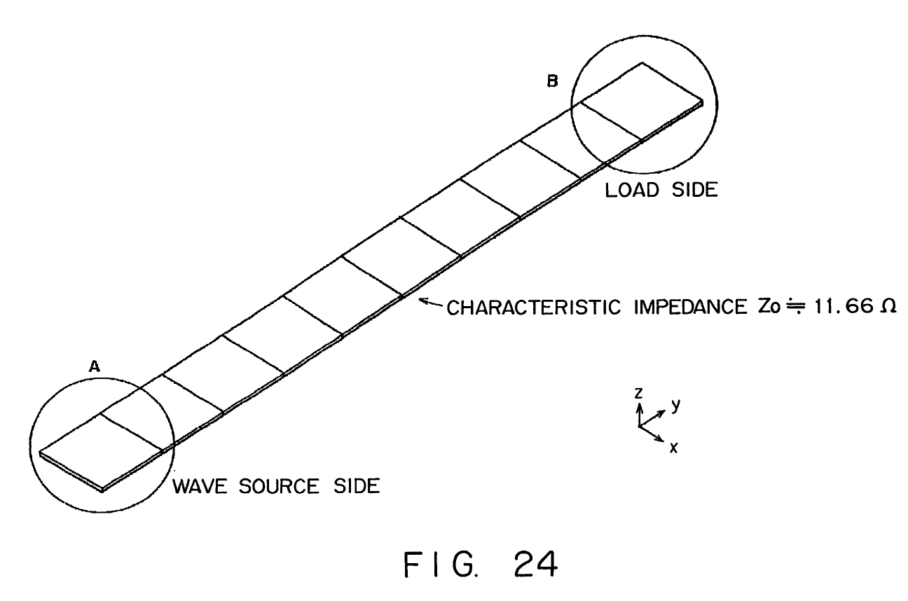

FIG. 24 shows a transmission line as an example of a closed circuit model. In FIG. 24, A indicates a wave source side, and B indicates a load side. The characteristic impedance Z0 of the transmission line is about 11.66 Ω.

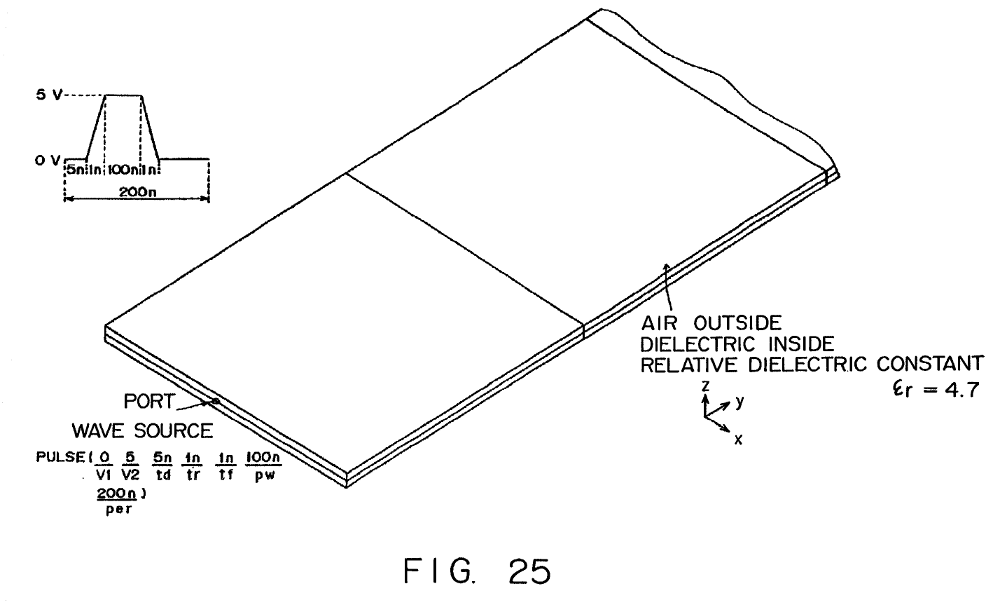

FIG. 25 is an enlarged view of the transmission line shown in FIG. 24, and a pulse-shaped voltage as shown on the upper left is applied to the port on the wave source side. The waveform is determined by the figures in parentheses preceded by PULSE on the lower left. The first V1 indicates the L level of the pulse, V2 indicates the H level, the next td indicates the delay time (5 ns) from time t=0 to the rise time tr of the pulse, the next tr indicates the rise time from the L level to the H level, the next tf indicates the fall time from the H level to the L level, the next pw indicates the continuation time at the H level as the pulse width, and the last per indicates 200 ns as a pulse cycle. A dielectric is detected inside the transmission line, and its relative dielectric constant ε_{γ} inside the transmission line is 4.7.

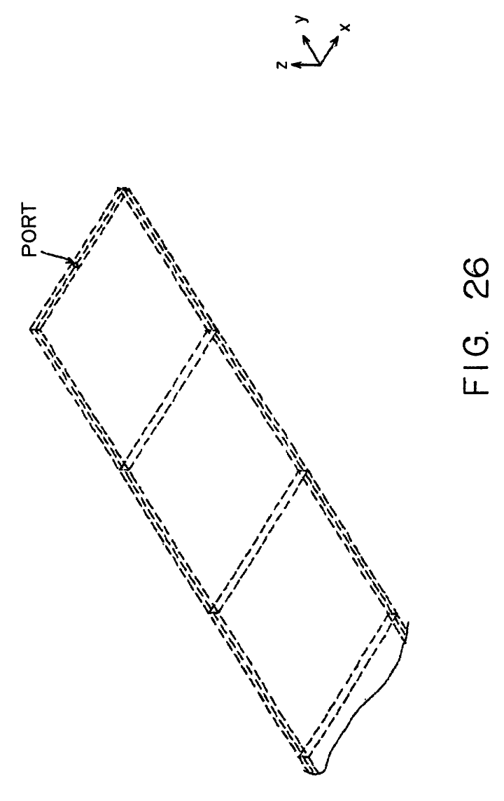

FIG. 26 is an enlarged view of the portion on the load side B shown in FIG. 24, and a load such as a resistor, a capacitor, etc. described later is connected to the port on the load side.

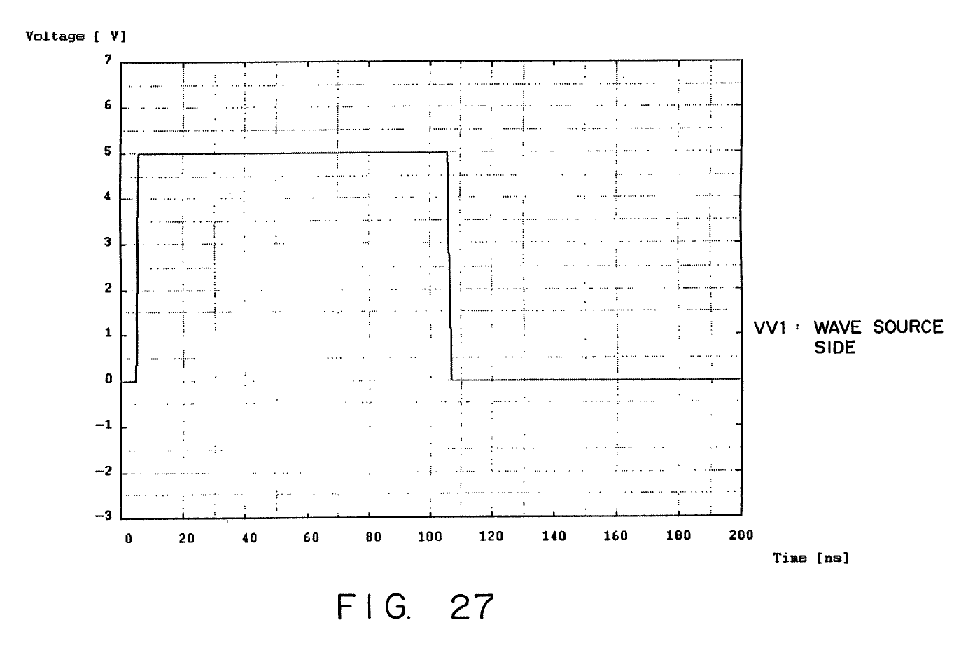

FIG. 27 shows a voltage waveform VVI applied on the wave source side, and is the same as the waveform on the upper left in FIG. 25.

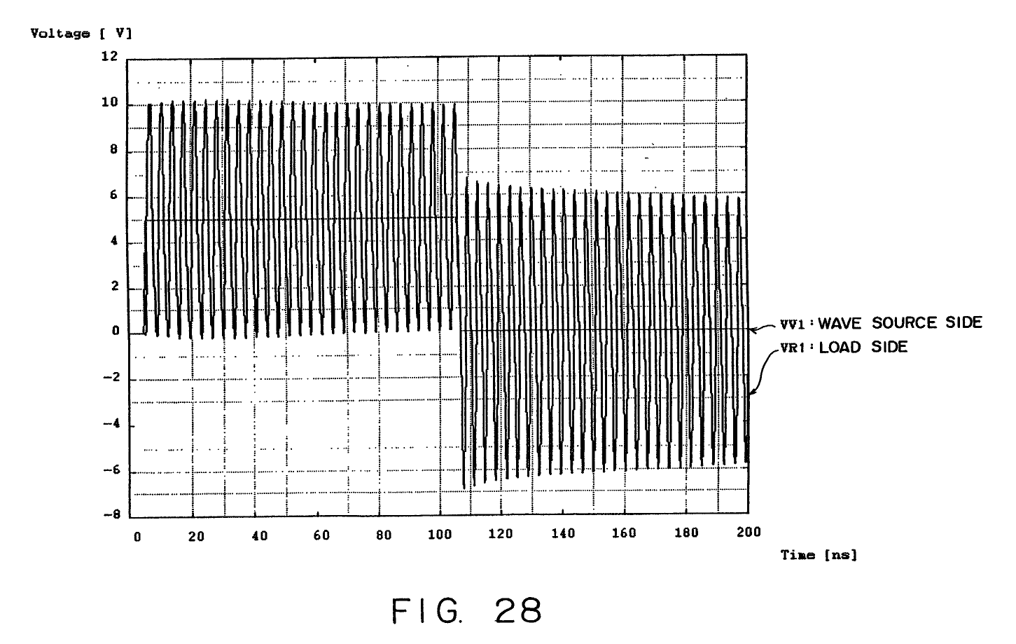

FIG. 28 shows the result of the voltage VR on the load side when the wave source in FIG. 27 is applied to the port on the wave source side and the port on the load side is open (through sufficiently large resistance, for example, R=10⁹Ω), together with the voltage VV1 on the wave supply side. In response to the input of the 5 V pulse, 10 V times 2 is reflected, and the reflection continues.

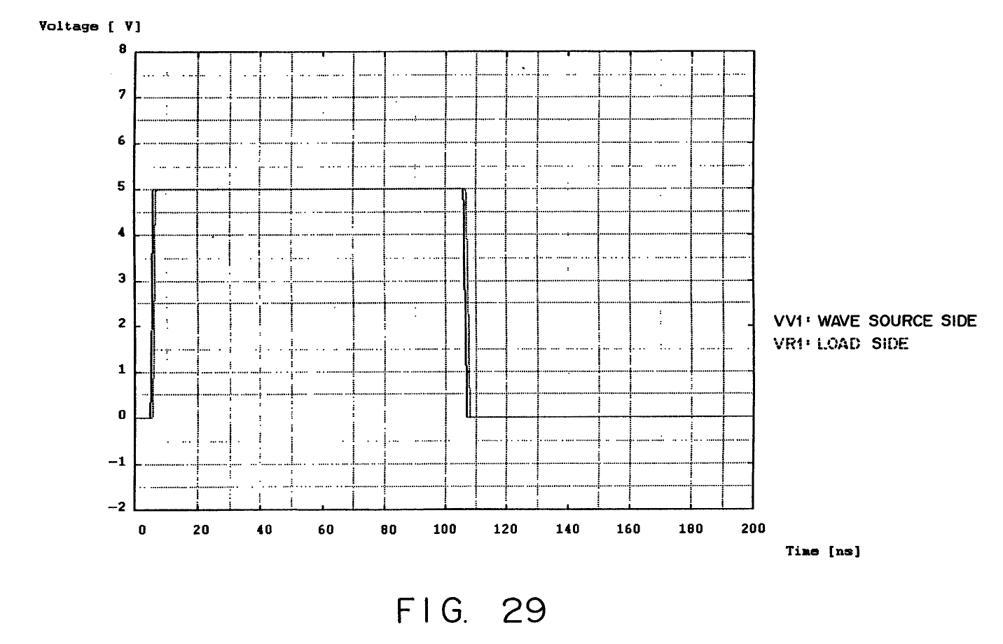

FIG. 29 shows the voltage VV1 on the wave source side and the voltage VR1 on the load side when the resistance matching the value of the characteristic impedance is connected to the port on the load side shown in FIG. 26, and the process terminates with consistency. The voltage VR1 tends to rise and fall with delay a little as compared with the voltage on the wave source side, but there arises no reflection because the process terminates with consistency. As a result, the two waveforms substantially match each other.

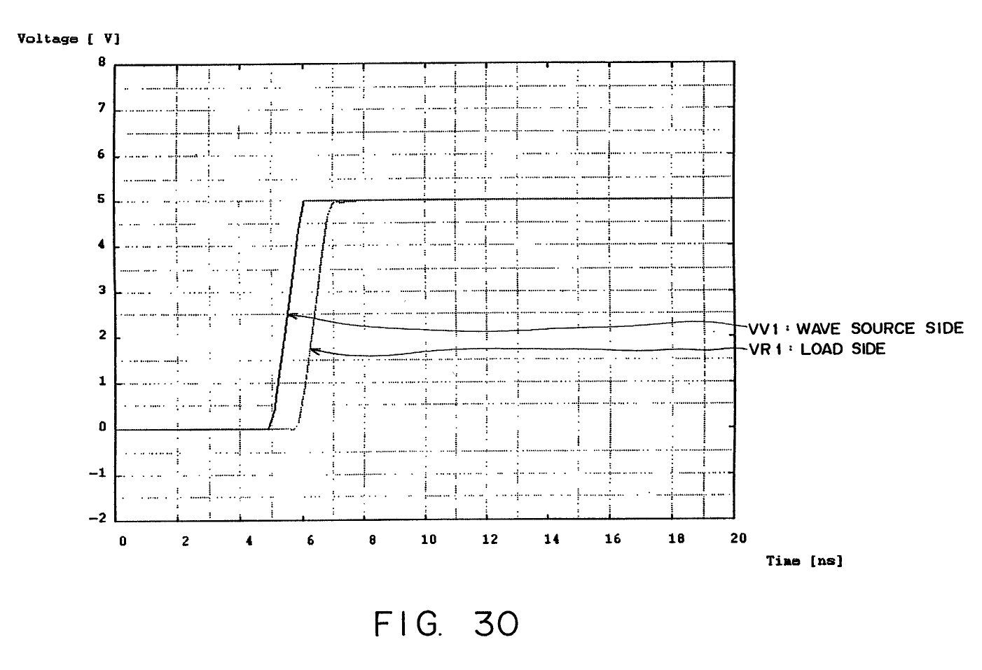

FIG. 30 is an enlarged view of the first portion of the waveform shown in FIG. 29. It shows that the voltage VR1 on the load side rises later than the voltage VV1 on the wave source side.

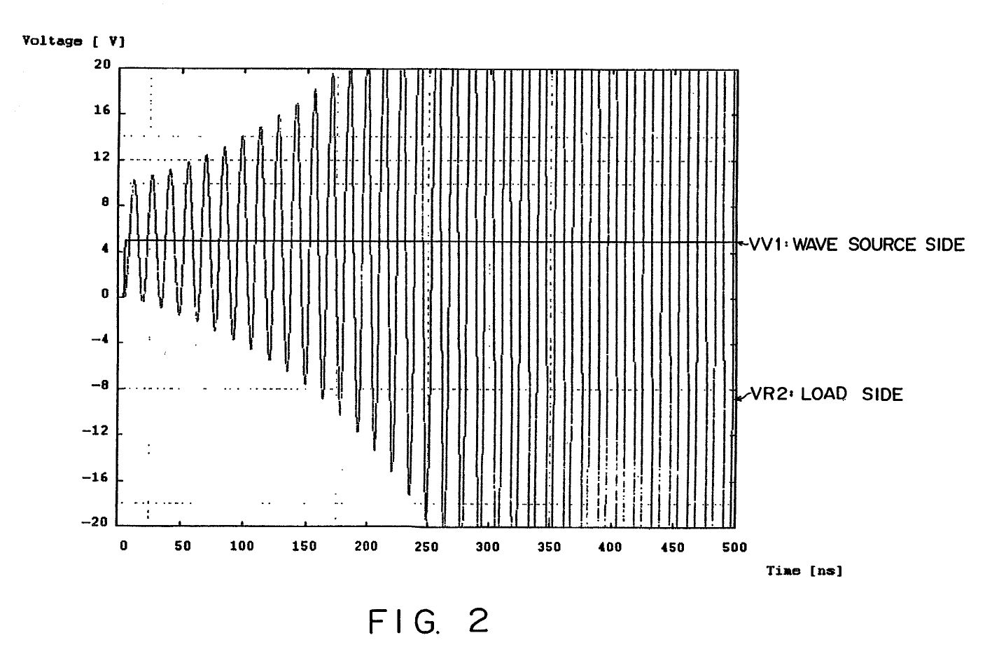

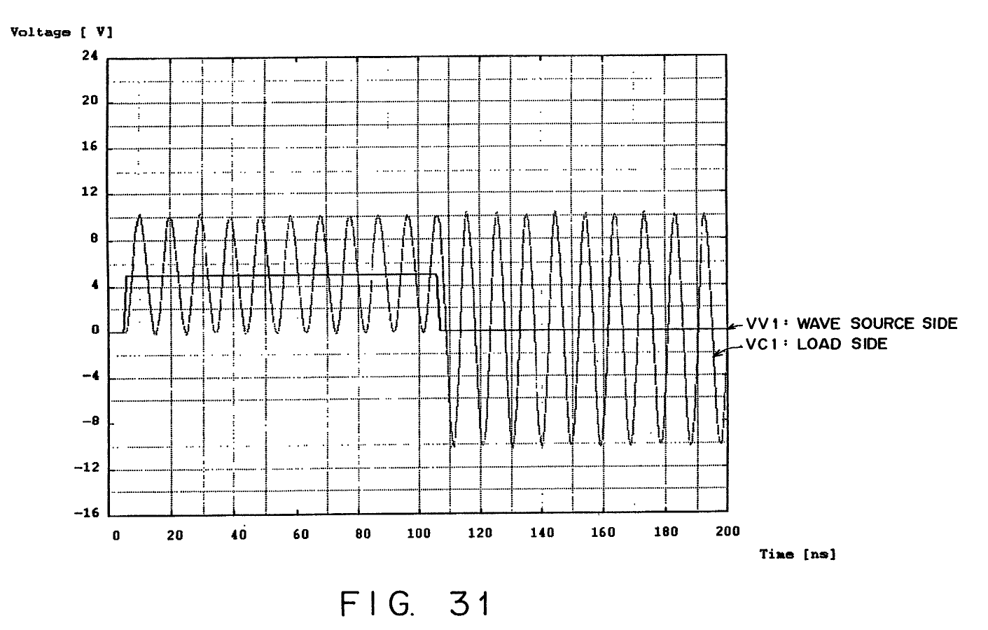

FIG. 31 shows the voltage VC1 on the load side, together with the voltage VV1 on the wave source side, when the capacitor 100pF is connected to the port on the load side. Although the amplitude of the oscillation doubles when the voltage reaches the L level, the dispersion as shown in FIG. 2 does not arise.

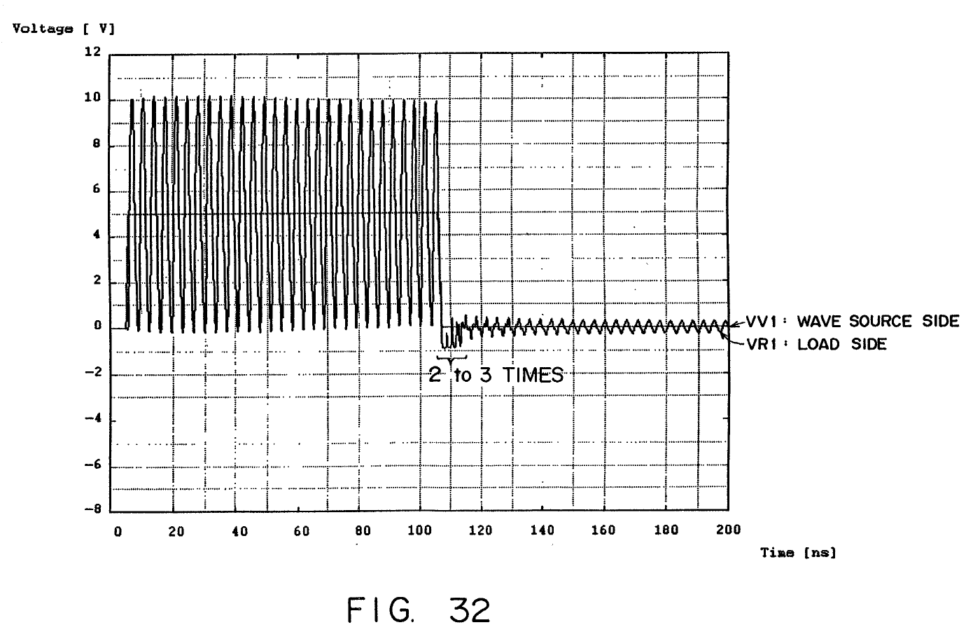

FIG. 32 shows an example of a voltage waveform when a diode is connected to the port on the load side. The diode is connected parallel to open resistance (=10⁹Ω) to the port on the load side. When an input voltage indicates the H level, double reflection is output. However, it indicates the L level, the waveform is clamped after the oscillation for two or three times.

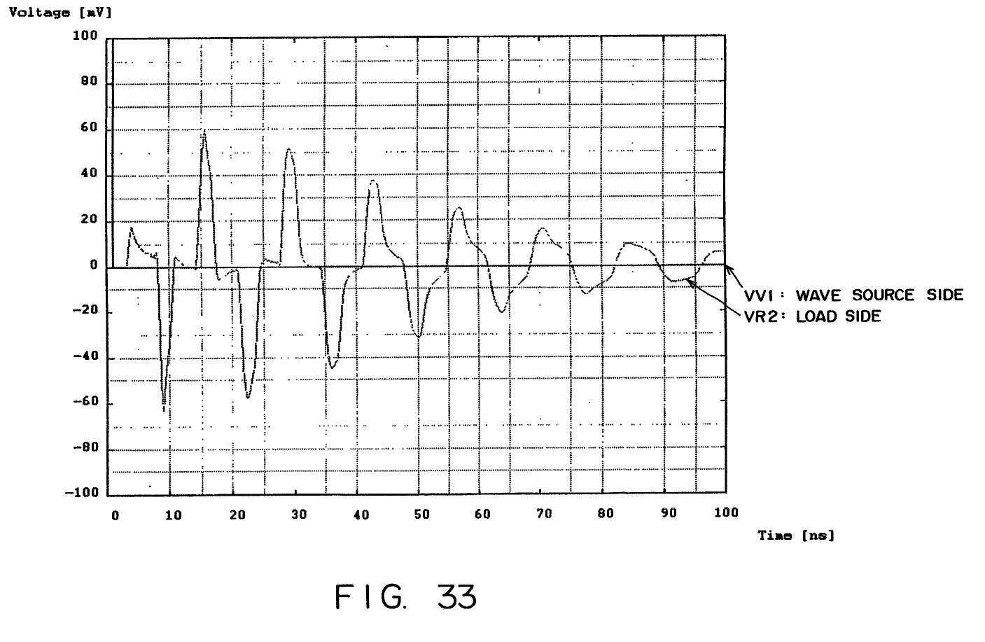

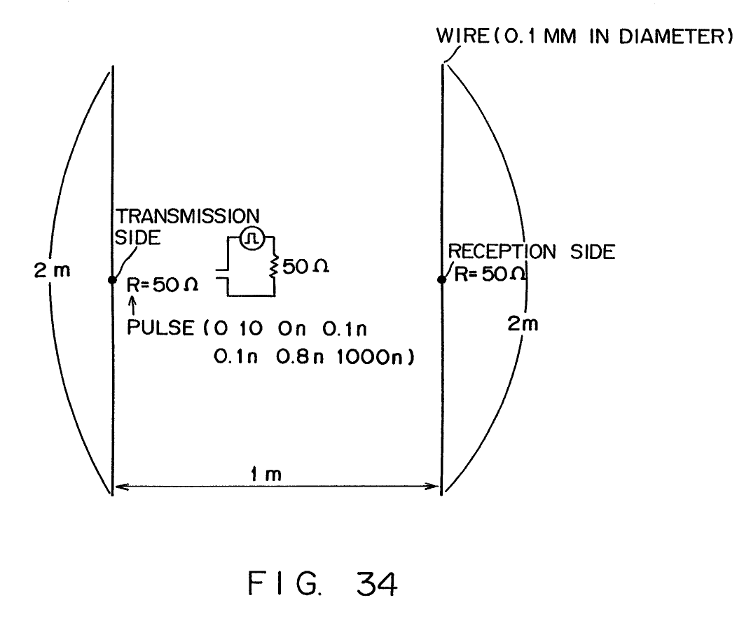

FIG. 33 shows an example of computation on an antenna model as an open circuit model. FIG. 34 shows a model for the computation example. On the transmission terminal side, a serial circuit of a pulse voltage waveform shown in parentheses preceded by PULSE and 50 Ω resistance is connected to the port at the center of the antenna element. The model on the reception terminal side includes 50 Ω resistance connected to the port at the center. As shown in FIG. 33, an appropriate computation result can be obtained for the open circuit model.

The process of computing an impulse response according to the present invention and its computation example are described above in detail. Described below are the conventional technology according to the document [1] described in the Description of the Related Art of this specification, and the comparison between the conventional technology and the technology according to the present invention.

As a practical example, assuming that the number nfft of the analytic frequencies in a frequency response is 256, the highest analytic frequency, that is, the Nyquist frequency fn is 2 GHz, the number p of ports is 2, the computation time for a set of simultaneous equations is A seconds, the computation time required to solve the simultaneous equations in the conventional technology is A×p×nfft/2=A×256 seconds. That is, the computation time for 256 sets of simultaneous equations is required. Then, the times of the convolutional computation for each computation time to obtain a time response is nfft ×p²=1024.

In the method according to the present invention, the number of the analytic frequencies for use in solving simultaneous equations is the number of analytic frequencies up to fa for which the real part of the frequency response is 0 initially. The value is set to, for example, 16, and the convolutional computation is performed only for the pulses to be retained. The pulse duration number m is set to 9 for example. In this case, the time required to solve the simultaneous equations is A×p×16=A×32 seconds, which is ⅛ of the conventional method. The times of the convolutional computation in obtaining one solution is 9×p2=36, which is 1/28 of the conventional method. Especially when the distance between ports is short, the value of fa is small, and the longer the time for a transient analysis is required, the larger the number of computation time points becomes, thereby improving the effect of the present invention.

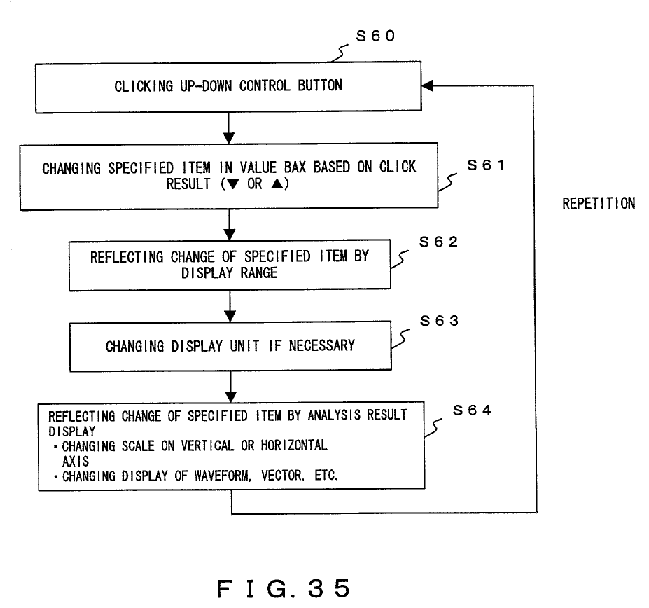

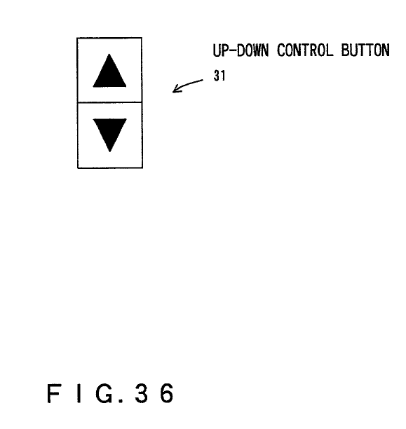

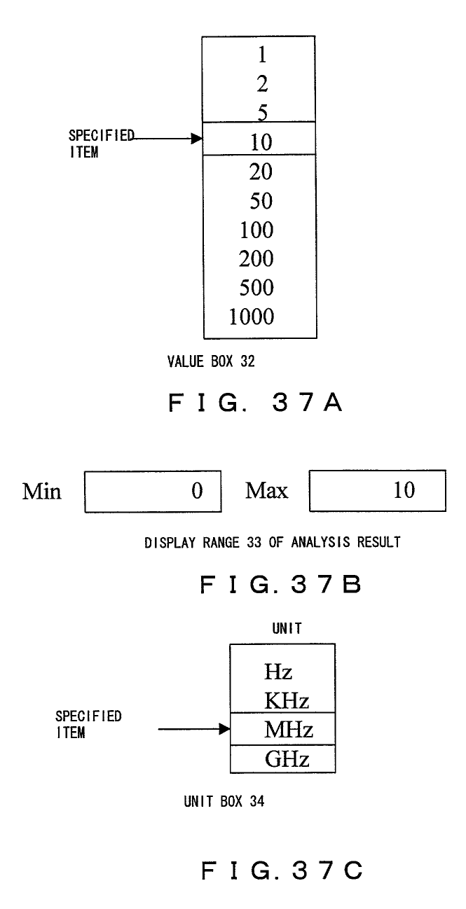

The process of displaying an analysis result obtained by the electromagnetic field intensity computation apparatus according to the present invention is described below by referring to FIGS. 35 through 38. FIG. 35 is a flowchart of the analysis result display changing process according to the present invention corresponding to the conventional process shown in FIG. 3. In FIG. 35, when a user clicks an up-down control button shown in FIG. 36 on the display screen of the electromagnetic field intensity computation apparatus in step S60, a specified item in a value box 32 shown in FIG. 37A is changed depending on “up” or “down” as a result of the click in step S51, the change is reflected in step S62 by a display range 33 shown in FIG. 37B, and the display unit is changed in step S63 as necessary.

The display unit is changed when the digits overflow as when a specified item in the value box 32 is increased from 1000, for example. In this case, the specified item in the value box 32 shown in FIG. 37C is automatically changed from MHz to GHz. That is, the unit display is switched for each 1000 times.

Then, the change of the specified item is reflected for the display as a result of the analysis result in step S64. That is, the scale of the vertical axis or the horizontal axis is changed, and the display of a waveform, a vector, etc. is changed. Afterwards, the processes in and after step S60 are repeated each time an up-down control button 31 is clicked.

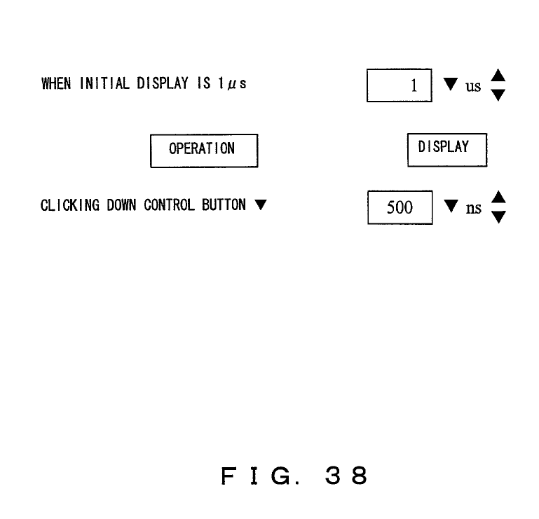

FIG. 38 shows an example of an operation performed when a down control button is clicked. Before a click, for example, if the down side of the up-down control button is clicked when the full scale of the horizontal axis is 1μs, the full scale is changed into 500 ns, and the unit is automatically changed when values are displayed.

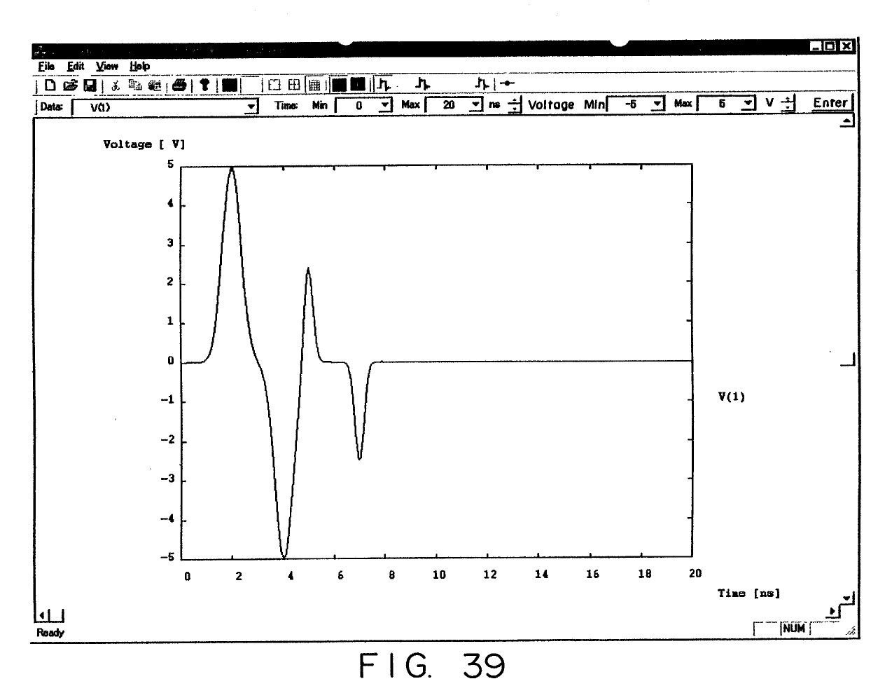

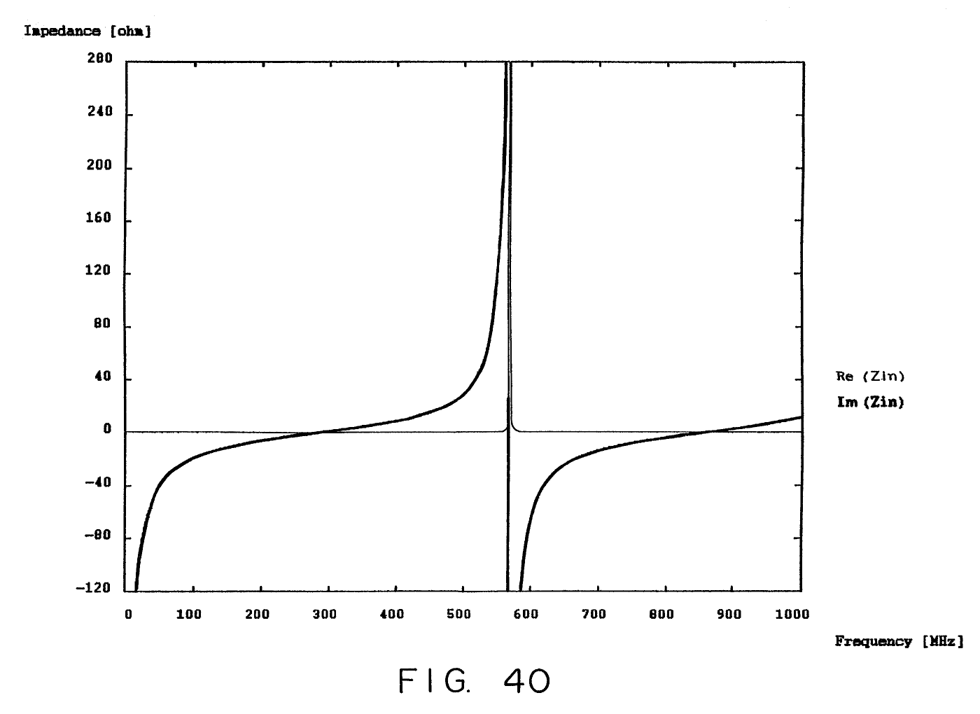

FIG. 39 shows an example of displaying a waveform viewer according to the embodiment of the present invention. FIG. 40 shows an example of displaying an input impedance. For example, in FIG. 39, an up-down control button is provided on the left of “Voltage”, or an up-down control button for a voltage is provided on the left of the Enter button.

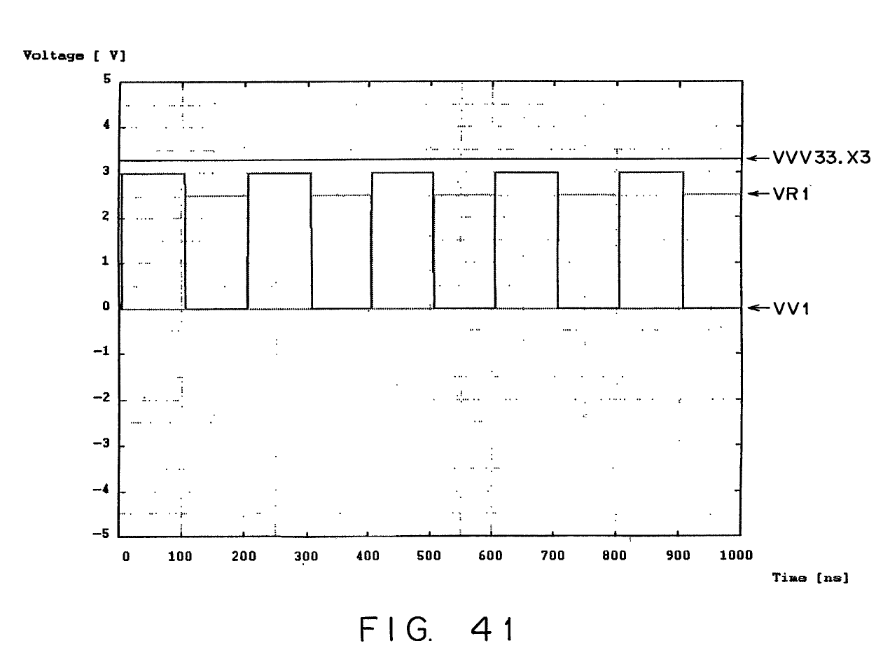

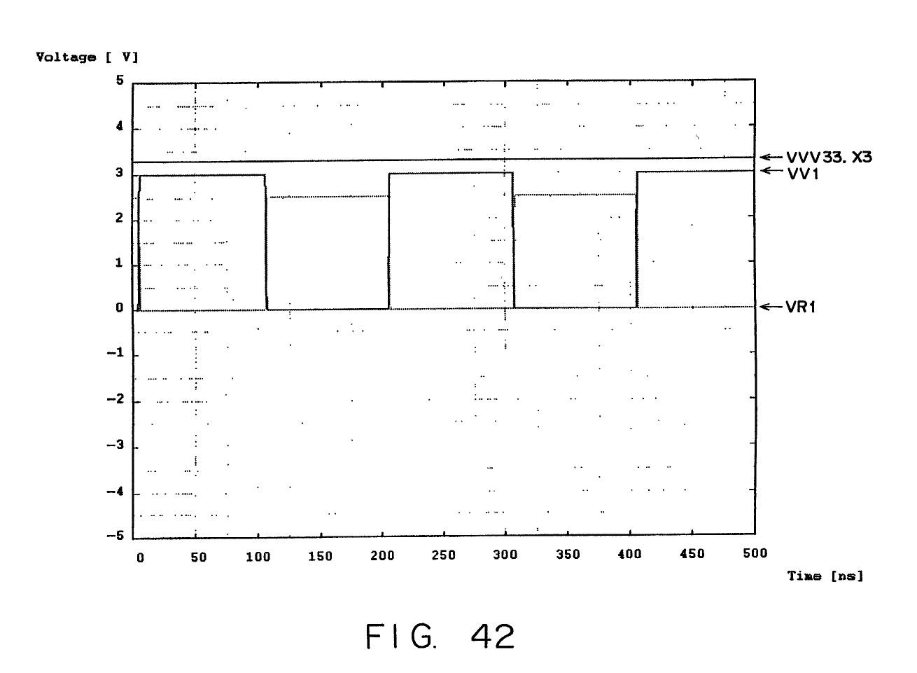

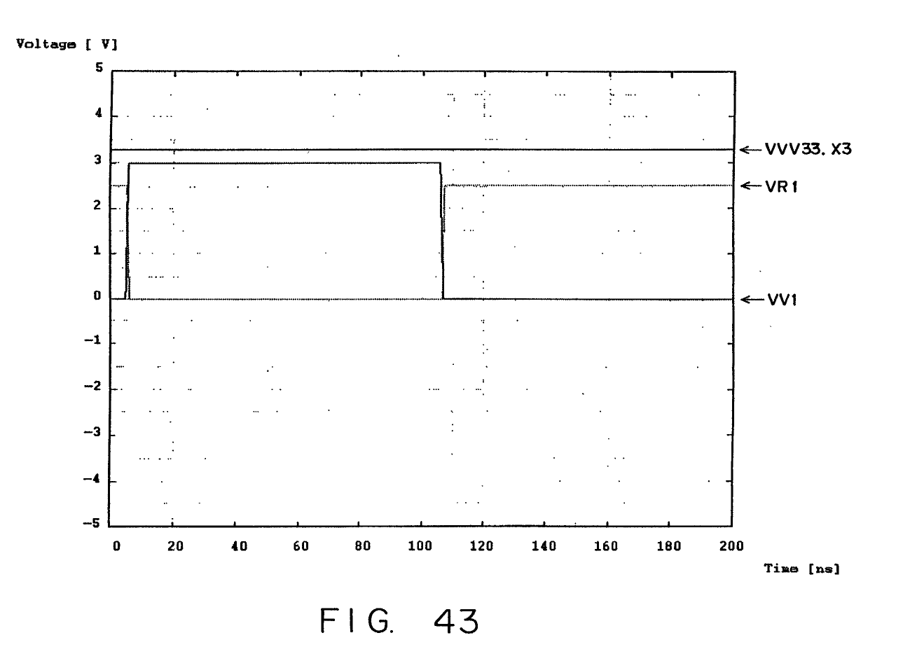

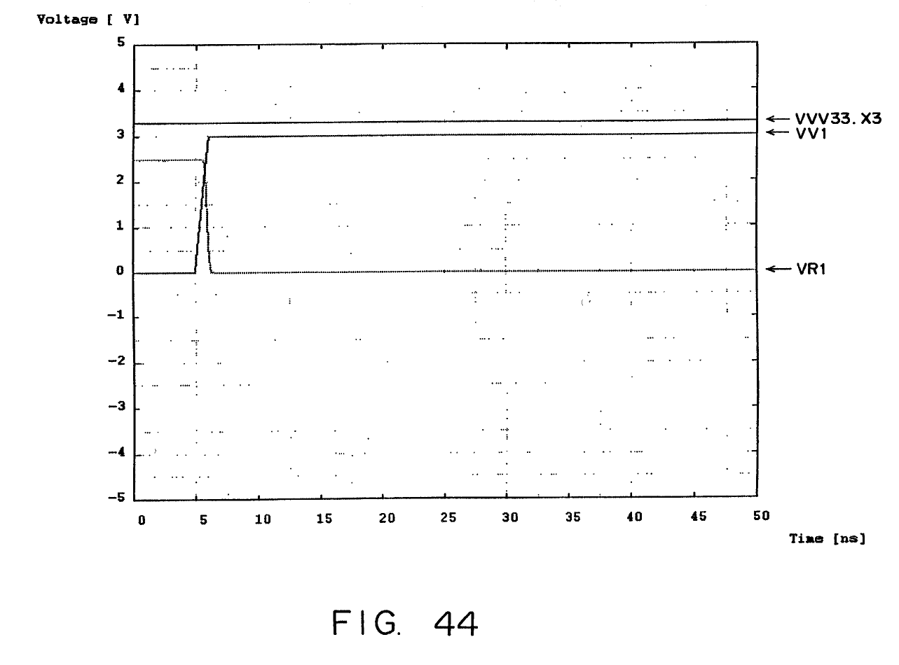

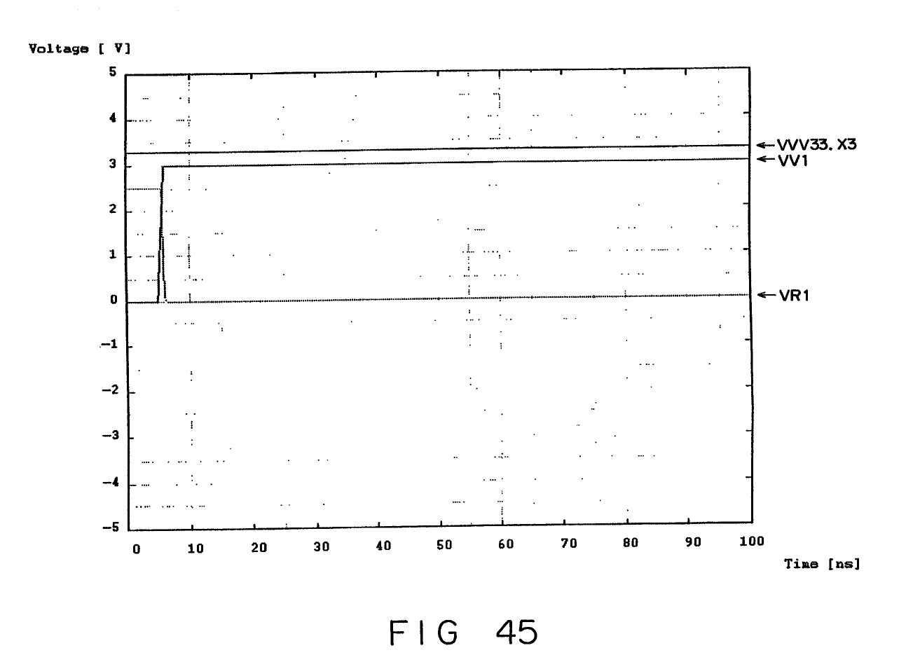

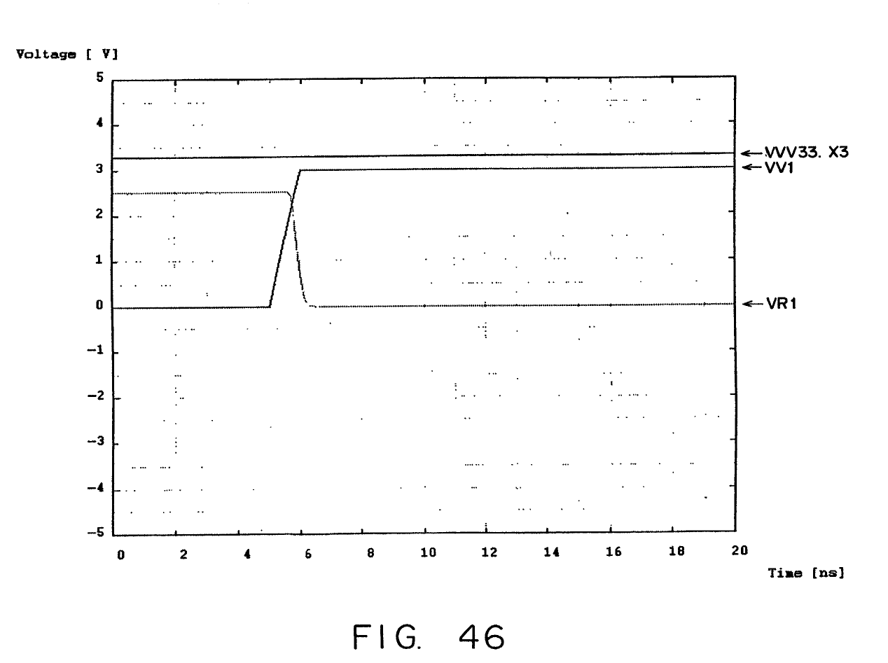

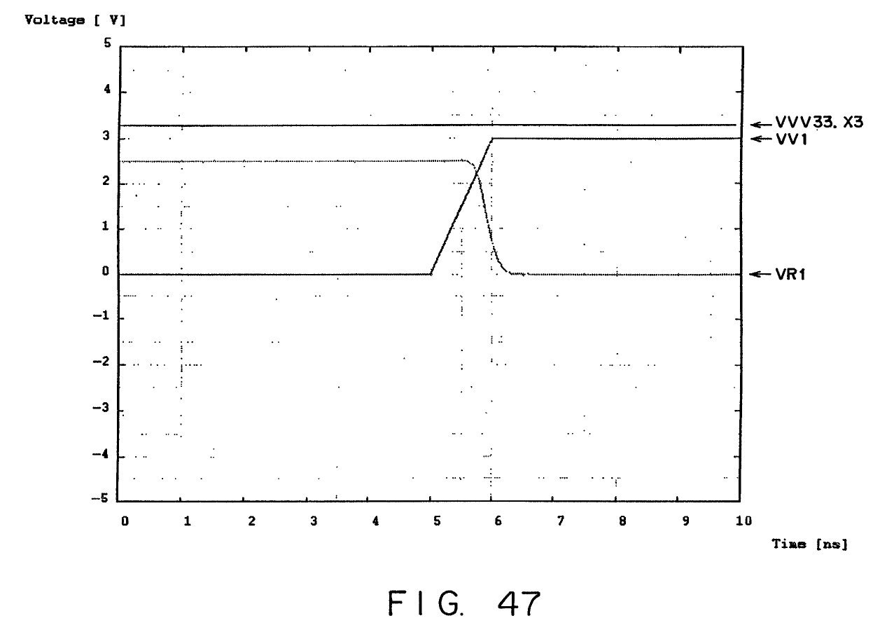

FIGS. 41 through 47 show examples of a display change result in a waveform viewer. In FIG. 41, a display is changed as shown in FIG. 42 by a click of the down button for time control. By repeating the click of the down button, the waveform display is sequentially changed as shown in FIGS. 43 through 47.

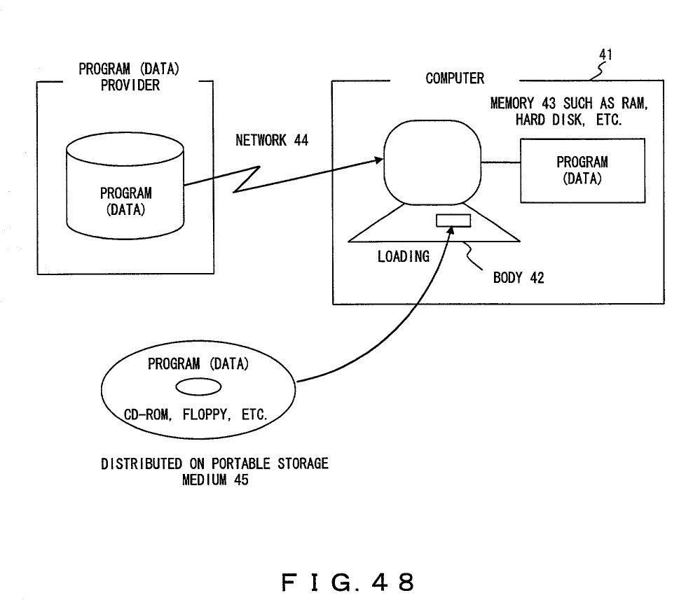

Described finally below is the process of realizing the electromagnetic field intensity computation apparatus according to the present invention as a computer system. The electromagnetic field intensity computation apparatus according to the present invention can be configured using a common computer system. FIG. 48 is a block diagram of the configuration of such a computer system. In FIG. 48, a computer system 41 is basically configured by a body 42 and memory 43 such as a hard disk, random access memory (RAM), etc.

In the process of computing an impulse response for the computation of the electromagnetic field intensity, the memory 43 stores a program for the process, and the program is executed by the body 42. The programs shown in the flowcharts in FIGS. 10, 11, 12, 13, 20, 21, and 35, and other programs for realizing the above mentioned processes are stored in the memory 43. The process of a transient analysis, the process of changing the display of an analysis result, etc. can be realized by executing the programs by the body 42.

These programs can also be executed by transmitting them from the program provider side to the computer system 41 through a network 44, and then loading the programs. In addition, they also can be executed by storing them in a marketed and distributed portable storage medium 45, and then loading the portable storage medium 45 onto the computer system 41.

The portable storage medium 45 can be any of various marketed and distributed storage media such as a floppy disk, CD-ROM, a magnetic disk, an optical disk, a magnetic optical disk, etc. These storage media store necessary programs for the present invention, and the programs are executed by the computer system 41, thereby performing the transient analysis and the process of changing the display of an analysis result according to the present invention.

The above mentioned electromagnetic field intensity computation apparatus can be configured by an information processing device such as a personal computer, etc.

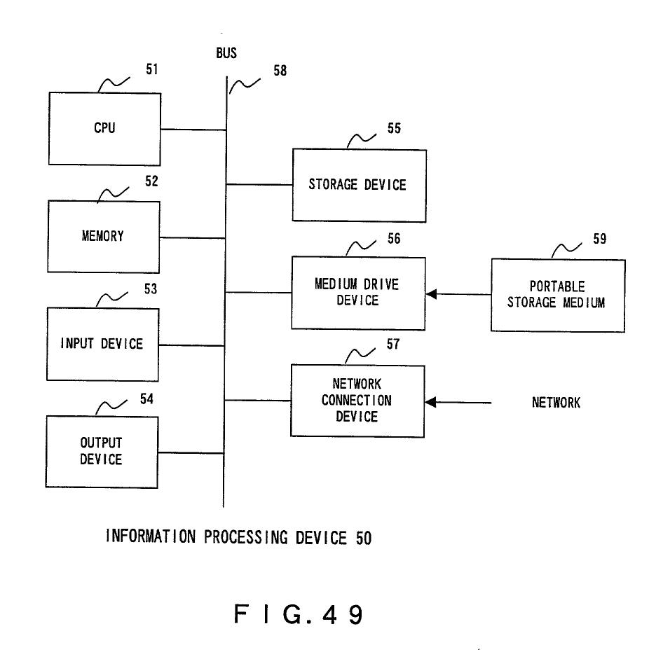

FIG. 49 shows an example of the configuration of the hardware of the information processing device realizing each of the above mentioned processes.

An information processing device 50 shown in FIG. 49 comprises a CPU 51, memory 52, an input device 53, an output device 54, a medium drive device 56, a medium drive device 56, and a network connection device 57. These devices are connected to a bus 58. The configuration shown in FIG. 49 is an example, and the present invention is not limited to this configuration.

The CPU 51 is a central processing unit for controlling the entire information processing device 50.

The memory 52 is memory such as the RAM, etc. for temporarily storing a program or data stored in the storage device 55 (or a portable storage medium 59) when the program is executed, the data is updated, etc. The CPU 51 executes each of the above mentioned processes using the program/data read to the memory 52.

The input device 53 can be a keyboard, a pointing device, a touch panel, etc., and is used when a user instruction and information are input.

The output device 54 can be, for example, a display, a printer, etc., and displays (or prints) various waveforms as the above mentioned (displayed) analysis result.

The storage device 55 can be, for example, a magnetic disk device, an optical disk device, a magnetic optical disk device, etc., and stores a program/data for realizing various processes and functions of the above mentioned electromagnetic field intensity computation apparatus.

Otherwise, these program/data can be stored in the portable storage medium 59. In this case, the program/data stored in the portable storage medium 59 are read by the medium drive device 56. The portable storage medium 59 can be, for example, an FD (floppy disk), CD-ROM, DVD, a magnetic optical disk, etc.

Furthermore, the above mentioned program/data can be stored in other external devices and downloaded through a network to which the system is connected through the network connection device 57. The present invention can also be configured as a storage medium (the portable storage medium 59, etc.) itself storing the block diagram program/data, can be configured as a network (a transmission medium) itself for transmitting the above mentioned program/data, and also can be configured as a transmission signal itself to be transmitted through the transmission medium when the program/data is downloaded.

Described above are the embodiments of the present invention. However, the present invention is not limited to the above mentioned applications, and it is obvious that other various embodiments can be adopted within the scope of the claims of the invention.

Especially, in the process of computing a frequency response and a time response, the operations in which, for example, the value nfft shown in FIG. 13 is set to a value increased to the power of 2 in step S42, the maximum value of the distance between ports is multiplied by 10 in step S46, the minimum value of nfft is set to 256 in step , the lengths of all analysis elements in the moment method are set in the range of 10-7λ through 0.25λ, the threshold for obtaining the pulse duration number is 1/10 of the maximum value in step S51 shown in FIG. 20, the amendment coefficient for use in setting the flat area, the transition area, and the cut-off area in step S56, amending a value, and stabilizing in step S57 is set to 0.95, etc. are all performed corresponding to the program installed according to the embodiment of the present invention, and it is obvious that the value is not fixed.

As described above, according to the present invention, computation can be performed by classifying an object to be analyzed into an open circuit model and a closed circuit model by performing a pseudo-DC analysis as a moment method analysis at a ultra low frequency to which the moment method can be applied, thereby computing a stable impulse response independent of a model, and suppressing the oscillation or dispersion of a solution as an analysis result.

In addition, the number of analytic frequencies in a frequency domain can be limited in the computation of a frequency response, and the pulse duration number can be limited in an impulse response, thereby considerably shortening the time required to solve simultaneous equations in the moment method, and reducing the times of the convolutional computation for one computation time point in an impulse response.

Furthermore, in the process of changing the display of an analysis result, an analysis result requested by a user can be displayed with less times of clicking operations by the user stepwise, continuously, and automatically changing the display without adjusting a unit, thereby remarkably reducing the operations of the user.

What is claimed is:

1. An electromagnetic field intensity computation apparatus for computing intensity of an electromagnetic field from an electric circuit device containing a nonlinear element, comprising:
an analytic frequency determination unit limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis unit performing a transient analysis on an analysis model corresponding to the analytic frequency determined by said analytic frequency determination unit.

2. The apparatus according to claim 1, further comprising:
a pseudo-DC analyzing unit performing a pseudo-DC analysis on an analysis model of the electric circuit device as a moment method analysis for an ultra low frequency to which the moment method can be applied; and
a model classification unit classifying the analysis model into a closed circuit model and an open circuit model depending on a size of a pseudo-DC component obtained as result of the pseudo-DC analysis, wherein
said transient analysis unit performs the transient analysis on the analysis model depending on a classification result.

3. An electromagnetic field intensity computation apparatus for computing intensity of an electromagnetic field from an electric circuit device containing a nonlinear element, comprising:
an analytic frequency determination unit limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis unit using a trapezoidal formula or a rectangular formula as an integral formula for a discrete integral equation when a time response is obtained by an inverse Fourier transform of the frequency response, and performing a transient analysis on an analysis model corresponding to the analytic frequency determined by said analytic frequency determination unit.

4. An electromagnetic field intensity computation apparatus for computing intensity of an electromagnetic field from an electric circuit device containing a nonlinear element, comprising:
an analytic frequency determination unit limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis unit idealizing the time response using one impulse when a time response is obtained by an inverse Fourier transform of the frequency response, and performing a transient analysis on the analysis model corresponding to the analytic frequency determined by said analytic frequency determination unit.

5. An electromagnetic field intensity computation apparatus for computing intensity of an electromagnetic field from an electric circuit device containing a nonlinear element, comprising:
an analytic frequency determination unit limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis unit idealizing the time response using two impulses when a time response is obtained by an inverse Fourier transform of the frequency response, and performing a transient analysis on an analysis model corresponding to the analytic frequency determined by said analytic frequency determination unit.

6. An electromagnetic field intensity computation apparatus for computing intensity of an electromagnetic field from an electric circuit device containing a nonlinear element, comprising:
an analytic frequency determination unit limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device;
a pseudo-DC analyzing unit performing a pseudo-DC analysis on an analysis model of the electric circuit device as a moment method analysis for an ultra low frequency to which the moment method can be applied;
a model classification unit classifying the analysis model into a closed circuit model when a pseudo-DC component obtained as result of the pseudo-DC analysis is large, and into an open circuit model when a pseudo-DC component is small; and
a transient analysis unit performing a transient analysis on the analysis model corresponding to a classification result of said model classification unit, and corresponding to the analytic frequency determined by said analytic frequency determination unit.

7. The apparatus according to claim 6, wherein
said transient analysis unit further comprises a pulse column adjustment unit for obtaining a threshold from an impulse column as a time response to the open circuit model, and removing an impulse smaller than the threshold.

8. The apparatus according to claim 7, wherein
said transient analysis unit further comprises a high band amendment unit for making an amendment to prevent high band oscillation to an impulse column from which an impulse smaller than the threshold has been removed by said pulse column adjustment unit.

9. The apparatus according to claim 6, wherein
said transient analysis unit further comprises a time causality adjustment unit for obtaining a time delay due to propagation velocity of a light from a time point of a signal input, and adjusting a time response to keep consistency with the time delay.

10. The apparatus according to claim 6, wherein
said transient analysis unit further comprises a unbalanced DC component adjustment unit for removing an unbalanced direct current component arising as an error in an analysis of the open circuit model from a time response.

11. The apparatus according to claim 6, wherein
said transient analysis unit further comprises a DC component removal unit for removing a direct current component from a time response obtained by performing an inverse Fourier transform on a frequency response to the closed circuit model.

12. The apparatus according to claim 11, wherein
said transient analysis unit further comprises a window function application unit for applying a window function for removal of a high band with the position of the maximum impulse set at the center in an impulse column forming a time response from which the direct current component has been removed.

13. The apparatus according to claim 11, wherein
said transient analysis unit further comprises a pulse column adjustment unit for obtaining a threshold from an impulse column as an output from said DC component removal unit, and removing an impulse smaller than the threshold.

14. The apparatus according to claim 13, wherein
said transient analysis unit further comprises a high band amendment unit for amending an output of said pulse column adjustment unit to prevent high band oscillation.

15. The apparatus according to claim 11, wherein
said transient analysis unit further comprises a time causality adjustment unit for obtaining a time delay due to propagation velocity of a light from a time point of a signal input for an impulse column as a time response from which the direct current component has been removed, and adjusting a time response to keep consistency with the time delay.

16. The apparatus according to claim 11, wherein
said transient analysis unit further comprises a unbalanced DC component adjustment unit for removing an unbalanced direct current component arising as an error in an analysis of the closed circuit model from a time response before adding again the removed direct current component.

17. A method for computing intensity of an electromagnetic field from an electric circuit device containing a nonlinear element, comprising:
limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
performing a transient analysis corresponding to the determined analytic frequency.

18. A method for computing intensity of an electromagnetic field from an electric circuit device containing a nonlinear element, comprising:
performing a pseudo-DC analysis on an analysis model of the electric circuit device as a moment method analysis for an ultra low frequency to which the moment method can be applied;
classifying the analysis model into a closed circuit model and an open circuit model depending on a size of a pseudo-DC component obtained as result of the pseudo-DC analysis; and
performing a transient analysis on the analysis model depending on a classification result.

19. The method according to claim 18, wherein:
in said transient analysis a direct current component is removed from a time response obtained by performing an inverse Fourier transform on a frequency response to the closed circuit model;
a threshold is obtained from an impulse column from which the direct current component has been removed; and
an impulse smaller than the threshold is removed from the impulse column.

20. A computer-readable storage medium storing a program used to direct a computer, for computing intensity of an electromagnetic field from an electric circuit device containing nonlinear element, to perform:
limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis corresponding to the determined analytic frequency.

21. A computer-readable storage medium storing a program used to direct a computer for computing intensity of an electromagnetic field from an electric circuit device containing nonlinear element, to perform:
a pseudo-DC analysis on an analysis model of the electric circuit device as a moment method analysis for an ultra low frequency to which the moment method can be applied;
classifying the analysis model into a closed circuit model and an open circuit model depending on a size of a pseudo-DC component obtained as result of the pseudo-DC analysis; and
a transient analysis on the analysis model depending on a classification result.

22. An electromagnetic field intensity computation apparatus which computes intensity of an electromagnetic field from an electric circuit device, comprising:
a display unit displaying a result of an analysis for the electric circuit device; and
a display instruction input unit receiving from a user an instruction to stepwise and automatically change a display scale and a display unit of the result of the analysis displayed on said display unit.

23. The apparatus according to claim 22, wherein
said displayed result of the analysis is a waveform viewer, an electromagnetic flow vector, an input impedance, or distribution of an electromagnetic flow.

24. A computer-readable storage medium storing a program used to direct a computer for computing intensity of an electromagnetic field from an electric circuit device, to perform:
receiving an instruction from a user to stepwise and automatically change a display scale of a result and a display unit when a result of an analysis for the electric circuit device is displayed; and
displaying an analysis result corresponding contents of the instruction.

25. An electromagnetic field intensity computation apparatus for computing intensity of an electromagnetic field from an electric circuit device containing a nonlinear element, comprising:
an analytic frequency determination means for limiting a range of an analytic frequency used in a moment method in a frequency domain, corresponding to an analysis condition of the intensity of the electromagnetic field from the electric circuit device, to a range up to a frequency nearest to a lowest value of the analytic frequency in frequencies having a real part of 0 in a frequency response as a result of an impulse response for an analysis model of the electric circuit device; and
a transient analysis means for performing a transient analysis on an analysis model corresponding to the analytic frequency determined by said analytic frequency determination means.
